(19) United States
(12) Patent Application Publication
(10) Pub. No.: US 2025/0096849 A1
(43) Pub. Date: Mar. 20, 2025

(54) WIRELESS CONTROL OF AUTOMOTIVE RIS TO ENHANCE IN-VEHICLE USER EXPERIENCE

(71) Applicant: QUALCOMM Incorporated, San Diego, CA (US)

(72) Inventors: Udita Bhattacherjee, San Diego, CA (US); Sourjya Dutta, San Diego, CA (US); Arzu Karaer, San Diego, CA (US); Shailesh Patil, San Diego, CA (US)

(21) Appl. No.: 18/468,869

(22) Filed: Sep. 18, 2023

(51) Int. Cl. H04B 7/04; H04L 5/00; H04W 56/00; H04W 72/044; H04W 72/542

(52) U.S. Cl. CPC H04B 7/04013; H04L 5/0053; H04W 56/001; H04W 72/044; H04W 72/542

(57) ABSTRACT

This disclosure provides systems, methods, and devices for wireless communication that support enhanced RIS configuration operations. In a first aspect, a method of wireless communication includes receiving a discovery beacon from a RIS controller of a vehicle. The method also include transmitting acknowledgement information in response to the discovery beacon. The method further includes receiving reconfigurable intelligent surface (RIS) configuration information for the vehicle based on the transmission of the acknowledgement information. The RIS configuration information indicates one or more RIS configurations of a plurality of RIS configurations for one or more RISs of the vehicle. Other aspects and features are also claimed and described.

### TECHNICAL FIELD

Aspects of the present disclosure relate generally to wireless communication systems, and more particularly, to configuration and control of reconfigurable intelligent surfaces (RISs). Some features may enable and provide improved communications, including enhanced signaling for configuring RISs to reduce signal path loss.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication includes: receiving a discovery beacon from a RIS controller of a vehicle; transmitting acknowledgement information in response to the discovery beacon; and receiving reconfigurable intelligent surface (RIS) configuration information for the vehicle based on the transmission of the acknowledgement information, the RIS configuration information indicating one or more RIS of configurations of a plurality of RIS configurations for one or more RISs of the vehicle.

In an additional aspect of the disclosure, an apparatus includes at least one processor and a memory coupled to the at least one processor. The at least one processor is configured to cause the apparatus to: receive a discovery beacon from a RIS controller of a vehicle; transmit acknowledgement information in response to the discovery beacon; and receive reconfigurable intelligent surface (RIS) configuration information for the vehicle based on the transmission of the acknowledgement information, the RIS configuration information indicating one or more of RIS configurations of a plurality of RIS configurations for one or more RISs of the vehicle.

In an additional aspect of the disclosure, an apparatus includes: means for receiving a discovery beacon from a RIS controller of a vehicle; means for transmitting acknowledgement information in response to the discovery beacon; and means for receiving reconfigurable intelligent surface (RIS) configuration information for the vehicle based on the transmission of the acknowledgement information, the RIS configuration information indicating one or more of RIS configurations of a plurality of RIS configurations for one or more RISs of the vehicle.

In an additional aspect of the disclosure, a non-transitory computer-readable medium stores instructions that, when executed by a processor, cause the processor to perform operations. The operations include: receiving a discovery beacon from a RIS controller of a vehicle; transmitting acknowledgement information in response to the discovery beacon; and receiving reconfigurable intelligent surface (RIS) configuration information for the vehicle based on the transmission of the acknowledgement information, the RIS configuration information indicating one or more of RIS configurations of a plurality of RIS configurations for one or more RISs of the vehicle.

In another aspect of the disclosure, a method for wireless communication for a RIS controller includes: transmitting a discovery beacon; receiving acknowledgement information responsive to the transmission of the discovery beacon; and transmitting RIS configuration information for one or more reconfigurable intelligent surfaces (RISs) associated with the RIS controller based on the acknowledgement information, the RIS configuration information indicating one or more RIS configurations of a plurality of RIS configurations for the one or more RISs.

In an additional aspect of the disclosure, an apparatus includes at least one processor and a memory coupled to the at least one processor. The at least one processor is configured to cause the apparatus to: transmit a discovery beacon; receive acknowledgement information responsive to the transmission of the discovery beacon; and transmit RIS configuration information for one or more reconfigurable intelligent surfaces (RISs) associated with the RIS controller based on the acknowledgement information, the RIS configuration information indicating one or more RIS configurations of a plurality of RIS configurations for the one or more RISs.

In another aspect of the disclosure, a method for wireless communication for a vehicle controller includes: transmitting a discovery beacon; receiving acknowledgement information responsive to the transmission of the discovery beacon; and transmitting RIS configuration information for the vehicle based on the acknowledgement information, the RIS configuration information indicating one or more RIS configurations of a plurality of RIS configurations for the one or more RISs of the vehicle.

In an additional aspect of the disclosure, a vehicle includes one or more reconfigurable intelligent surfaces (RISs) and a reconfigurable intelligent surface (RIS) controller. The RIS controller is configured to: transmit a discovery beacon; receive acknowledgement information responsive to the transmission of the discovery beacon; and transmit RIS configuration information for the vehicle based on the acknowledgement information, the RIS configuration information indicating one or more RIS configurations of a plurality of RIS configurations for the one or more RISs of the vehicle.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3A is a block diagram illustrating an example wireless communication system illustrating reconfigurable intelligent surface (RIS) based communication operations according to one or more aspects.

FIG. 3B is a block diagram illustrating an example of a vehicle including a plurality of RISs according to one or more aspects.

FIG. 4 is a block diagram illustrating an example wireless communication system that supports enhanced RIS configuration operations according to one or more aspects.

FIG. 5 is a flow diagram illustrating an example process that supports enhanced RIS configuration operations according to one or more aspects.

FIG. 6 is a flow diagram illustrating an example process that supports enhanced RIS configuration operations according to one or more aspects.

FIG. 7 is a flow diagram illustrating an example process that supports enhanced RIS configuration operations according to one or more aspects.

FIG. 8A is a block diagram illustrating an example of a configuration file that supports enhanced RIS configuration operations according to one or more aspects.

FIG. 8B is a flow diagram illustrating another example of a configuration file that supports enhanced RIS configuration operations according to one or more aspects.

FIG. 9 is a flow diagram illustrating an example process that supports enhanced RIS configuration operations according to one or more aspects.

FIG. 10 is a flow diagram illustrating an example process that supports enhanced RIS configuration operations according to one or more aspects.

FIG. 11 is a block diagram of an example UE that supports enhanced RIS configuration operations according to one or more aspects.

FIG. 12 is a block diagram of an example base station that supports enhanced RIS configuration operations according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

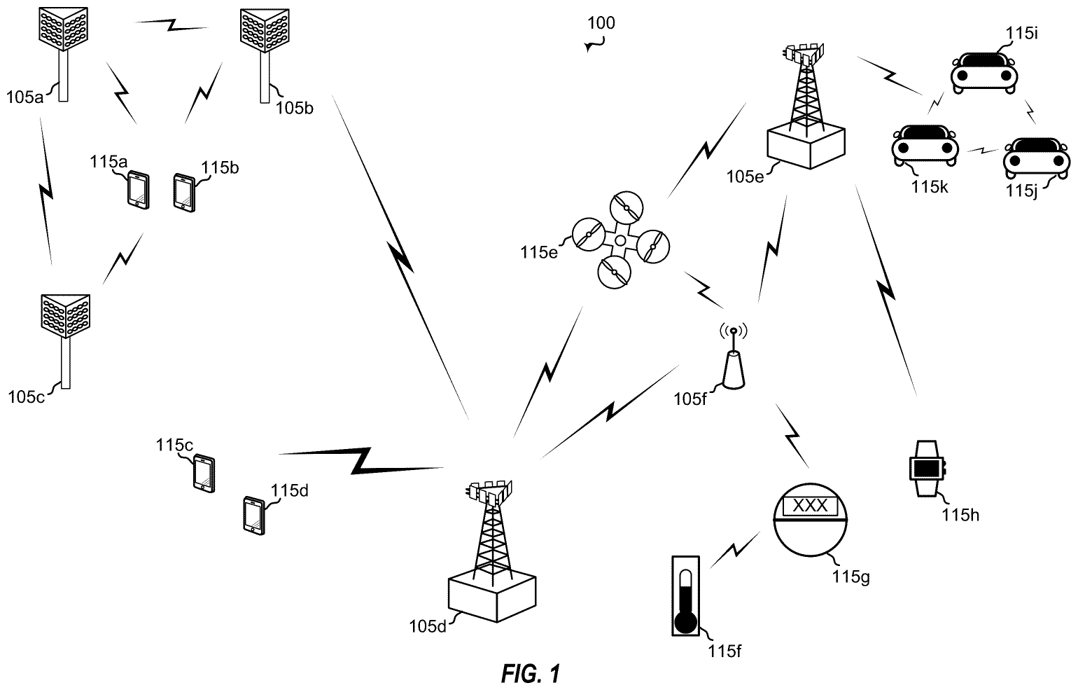

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

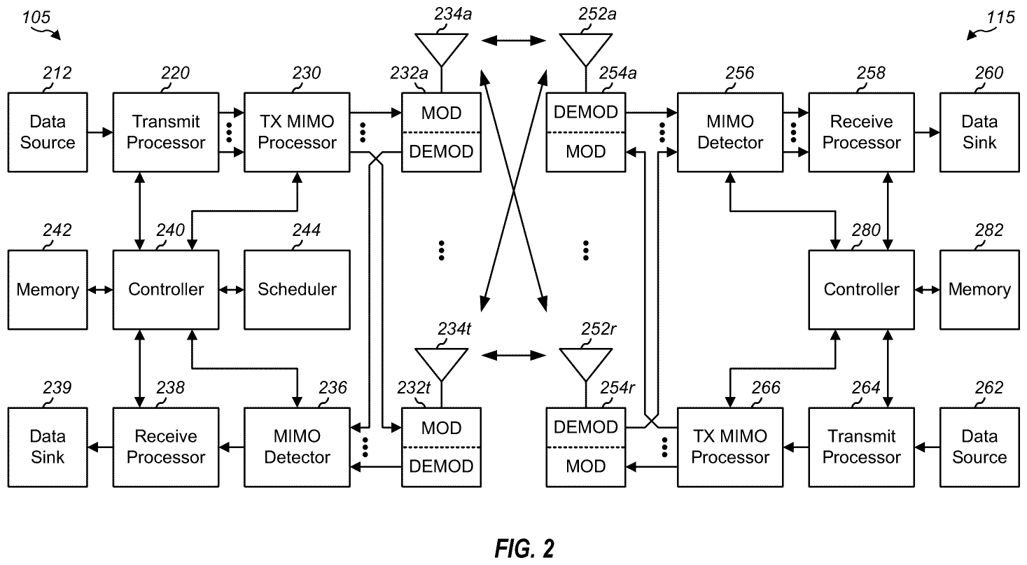

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

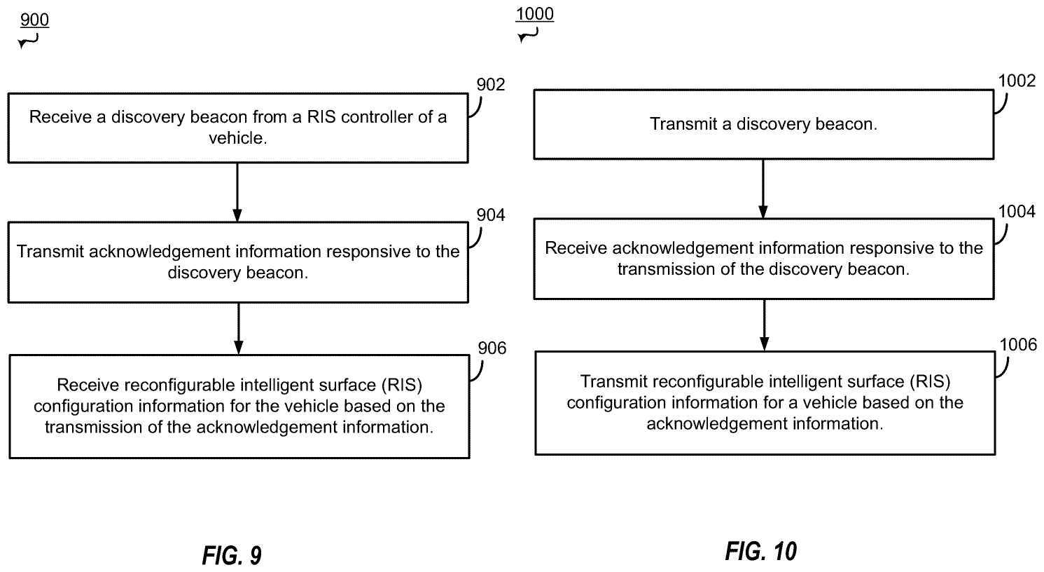

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 9 and 10, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

A reconfigurable intelligent surface (RIS) is a configurable device or component which can be used to improve a signal or link quality between two devices. A RIS may include or correspond to a meta-surface equipped with a large number of passive and/or programmable elements which adjust an electromagnetic field, and accordingly incoming wireless signals and radio channels. With a RIS, a signal propagation environment (e.g., the inside of a vehicle or building) can be changed to a more favorable condition so as to improve the link quality.

A RIS may include programmable/configurable meta-material that operates based on the principle of anomalous refraction and reflection. A RIS can reflect or transmit the incident signal at a different or configurable angle when controlled electrically where this different or configurable angle is not dictated by classical Snell's law. Thus, one or more RISs may be used to intelligently modify the wireless environment and signal prorogation to improve communications.

For example, a vehicle may include a plurality of small reflecting/refracting units (e.g., meta-atoms) that can adjust a phase (impart a phase shift or gradient) on the incident waveform leading to anomalous refraction and/or reflection. A RIS may include or correspond to a transparent RIS or a transmissive RIS. In some implementations, a transparent RIS may be used on glass surfaces (e.g., windows, windshields, sunroof) of a vehicle or a building. Such transparent RISs may have a transparency of greater than 80 percent.

When a RIS or RISs are included in a vehicle or building, they may help to counter the penetration loss for wireless systems within the vehicle (e.g., a telematics system) or building, and/or for user equipment (UE) operating inside the vehicle or building. Outdoor-to-indoor loss is a major factor in signal strength and quality loss, especially in higher frequency bands, such as for next-generation Wi-Fi and cellular systems. A signal which would otherwise be reflected and/or refracted away from a recipient device, may be adjusted to be converted to a direct path with the help of one or more RISs.

Additionally, including one or more RISs in a vehicle or building may reduce multiple reflections inside the vehicle or building. For example, a reflective RIS may be used to keep noise and interference out by reflecting unwanted exterior electromagnetic radiation away from the device.

In some implementations, a RIS is a passive element that doesn't draw power from a source, such as a vehicle battery or a building power source. Rather, the RIS may be coupled to a controller, a RIS controller, which can electrically configure the RIS according to the environment and to improve a particular communication path/link. In some such implementations, a RIS system of a vehicle or a building may be setup with one or more controllers which are configured to control respective groups of RISs of a plurality of RISs. For example, in one particular implementation, a single, central RIS controller may be used to electrically configure each RIS, as a central control system.

The RIS controller may be configured to activate and deactivate individual RISs of the system and/or adjust a reflection or transmission angle of the individual RISs. The system may include one or more different types of RIS, such as a transparent RIS, a transmission RIS, a reflective RIS, etc. Each individual RIS may have a plurality of modes or configurations. For example, one RIS may have two modes, such as active and inactive (or activated or not activated). When active/activated, the RIS may be configured for a transmission mode (e.g., refractive mode) or a reflective mode. As another example, a different RIS may have three modes. To illustrate, the RIS may have multiple activate modes and an inactive mode. As illustrative examples of the modes, the RIS may be a) activated in transmission mode, b) activated in a reflective mode, c) activated in a transmissive and reflective mode, d) partially activated (e.g., partially transmissive or reflective), or e) completely deactivated.

In some implementations, the RISs are configured based on electrical control determined by the RIS controller through a conductive connection between the RIS meta-elements and the RIS controller. Additionally, or alternatively, the RIS controller may be configured to control one or more RISs wirelessly. For example, the RIS controller may be configured to wirelessly send control signals and/or power (e.g., power signals) to the RISs. The RIS controller may be a low-power device, such as a lower power and complexity device as defined in wireless standards.

As an example illustration of a use case for RISs, an in-vehicle UE can have a substantial loss in performance due to outside-to-inside penetration losses. In sub-6 GHz band, the observed loss may be 7-10 dB, and the loss can be even higher for higher frequencies as used in next generation wireless communication systems. Additionally, next generation wireless systems and higher frequency communications often employ directional (e.g., beamformed) communications which also face greater losses from communication path losses.

A vehicle or building with a RIS system can be configured to improve link performance in multiple scenarios. A system with a RIS controller (e.g., central RIS controller) can be more power efficient than a conventional relay or repeater for vehicle or building control of multiple RISs, as a RIS may not have active antennas or RF chains like a repeater/relay. RIS systems can help the UE to save power by reducing frequent beam switching, link failure (e.g., multiple attach scenarios), etc. The efficient control of RISs of the system can help in maintaining link stability over longer durations leading to fewer hand-overs, beam switches, MCS changes, etc.

Moreover, in some cases a UE or system may off-load a part of the beam management implicitly to the RIS controller. For example, the UE performs fewer beam switches and maintains a fixed beam to a particular RIS or groups of RISs, while the RIS controller adjusts one or more RISs to propagate beams from the UE outward and to redirect incoming beams from different/changing directions to the UE. To illustrate, the RISs may correspond to adjustable RISs which support a range of incident angles, and the RIS controller may maintain the transmitted angle constant towards the UE.

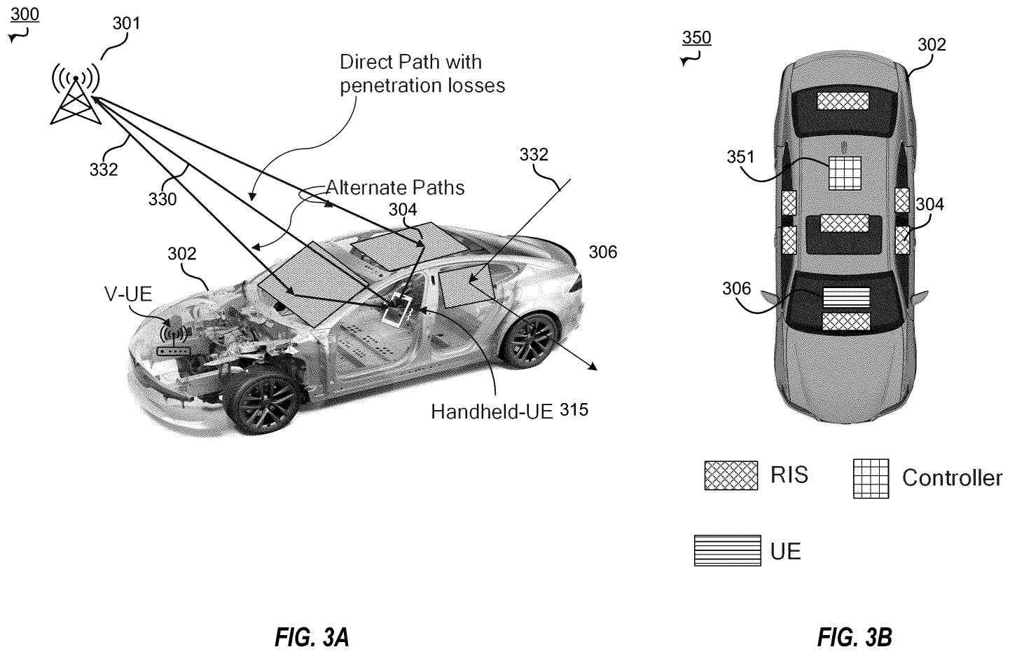

The UE may communicate with the low power RIS controller using a side channel over unlicensed technology, Wi-Fi, Bluetooth, or other wireless technologies suitable to device-to-device (D2D) and IoT communications, to improve communications on a second wireless network or technology, such as cellular. An example RIS system is illustrated in FIGS. 3A and 3B.

FIG. 3A illustrates an example diagram illustrating a wireless communications system, system 300, for RIS operation. In FIG. 3A, the system 300 includes a base station 301, a vehicle 302, and a UE 315, which is located inside of the vehicle. As illustrated in the examples of FIG. 3A, the vehicle 302 includes a plurality of RIS 304 and a RIS controller 351. The vehicle 302 may optionally include a vehicle UE, such as a vehicle UE 306. The vehicle UE 306 may be located within the vehicle 302 in some implementations, which may lead to greater path loss than externally mounted vehicle UEs or vehicle UEs with external antennas.

During operation, the base station 301 may communicate with the vehicle UE 306, the UE 315, or both. A direct path 320 between the base station 301 and the vehicle UE 306 and/or the UE 315 may result in path loss. The RIS controller 351 may communicate with the UE 315, the vehicle UE 306, or both to adjust one or more RISs of the vehicle to create one or more additional signals paths 322 and 324.

Additionally, or alternatively, the RIS controller 351 may adjust one or more RISs of the vehicle to block one or more other signals paths, such as interference related signal paths. Signal paths 332 and/or 334 may result in destructive interference to the vehicle UE 306 and/or 315 inside the car. The RIS controller 351 may adjust one or more RISs to prevent signal paths 332 and/or 334 from entering the car by configuring at least one RIS in reflected mode.

FIG. 3B illustrates an example diagram illustrating the vehicle 302 of FIG. 3B and illustrative locations for RISs. In FIG. 3B, the vehicle 302 includes a plurality of RISs 304, the vehicle UE 306, and the RIS controller 351. In the example of FIG. 3B, the vehicle 302 includes 7 RISs, one each on the front and back windshields, one on the sunroof, and one each on the passenger and driver side windows.

In the aspects described herein, RIS configuration may be enhanced by adding a low power RIS controller for interacting with UEs to control and allow for remote configuration of RISs of a vehicle or building. The configuration of the RISs by the UE enables reduced signal path loss, which may improve signal strength and enable higher modulation coding schemes (MCSs). Accordingly, errors may be reduced and overall throughput may be increased.

In the techniques described herein, RIS configuration schemes for supporting flexible and enhanced RIS configuration via a dedicated RIS controller are disclosed along with operations for determining when and how to configure the RISs of the system.

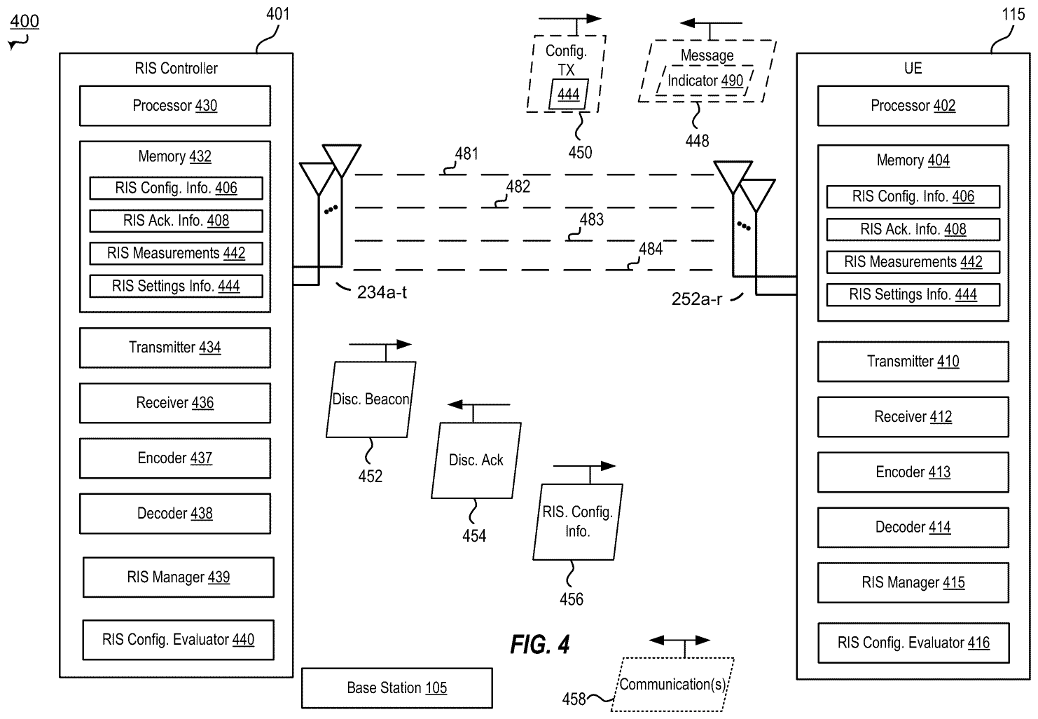

FIG. 4 illustrates an example of a wireless communications system 400 that supports enhanced RIS configuration operations in accordance with aspects of the present disclosure. In some examples, wireless communications system 400 may implement aspects of wireless network 100. For example, wireless communications system 400 may include a network, such as one or more network entities, one or more UEs, such as UE 115, and one or more RIS controllers, such as RIS controller 401. As illustrated in the example of FIG. 4, the network entity includes a corresponds to a base station, such as base station 105. Alternatively, the network entity may include or correspond to a different network device (e.g., not a base station).

The devices of the network, such as UE 115, may also communicate with a RIS controller, such as RIS controller 401, to perform enhanced RIS configuration operations. For example, the UE 115 may be in range of a RIS controller which is associated with and in control of one or RIS which are in a signal path of the UE 115 and base station 105. A RIS or RISs may be adjusted to alter signal paths to reduce signal path loss between the UE 115 and base station 105. Enhanced RIS configuration operations may reduce latency and errors and increase throughput by improving signal paths. For example, adjusting a configuration of one or more RISs may reduce signal path loss and improve signal strength and quality, leading to improved network operations. Accordingly, network and device performance can be increased.

Base station 105, UE 115, and RIS controller 401, may be configured to communicate via one or more portions of the electromagnetic spectrum. The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “mmWave” band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

It is noted that subcarrier spacing (SCS) may be equal to 15, 30, 60, or 120 kHz for some data channels. Base station 105, UE 115, and RIS controller 401 may be configured to communicate via one or more component carriers (CCs), such as representative first CC 481, second CC 482, third CC 483, and fourth CC 484. Although four CCs are shown, this is for illustration only, more or fewer than four CCs may be used. One or more CCs may be used to communicate control channel transmissions, data channel transmissions, and/or sidelink channel transmissions.

Such transmissions may include a Physical Downlink Control Channel (PDCCH), a Physical Downlink Shared Channel (PDSCH), a Physical Uplink Control Channel (PUCCH), a Physical Uplink Shared Channel (PUSCH), a Physical Sidelink Control Channel (PSCCH), a Physical Sidelink Shared Channel (PSSCH), or a Physical Sidelink Feedback Channel (PSFCH). Such transmissions may be scheduled by aperiodic grants and/or periodic grants.

Each periodic grant may have a corresponding configuration, such as configuration parameters/settings. The periodic grant configuration may include configured grant (CG) configurations and settings. Additionally, or alternatively, one or more periodic grants (e.g., CGs thereof) may have or be assigned to a CC ID, such as intended CC ID.

Each CC may have a corresponding configuration, such as configuration parameters/settings. The configuration may include bandwidth, bandwidth part, hybrid automatic repeat request (HARQ) process, TCI state, RS, control channel resources, data channel resources, or a combination thereof. Additionally, or alternatively, one or more CCs may have or be assigned to a Cell ID, or a Bandwidth Part (BWP) ID. The Cell ID may include a unique cell ID for the CC, a virtual Cell ID, or a particular Cell ID of a particular CC of the plurality of CCs. Additionally, or alternatively, one or more CCs may have or be assigned to a HARQ ID. Each CC may also have corresponding management functionalities, such as, beam management or BWP switching functionality. In some implementations, two or more CCs are quasi co-located, such that the CCs have the same beam and/or same symbol.

In some implementations, control information may be communicated via base station 105, UE 115, and/or RIS controller 401. For example, the control information may be communicated using MAC-CE transmissions, Radio Resource Control (RRC) transmissions, DCI (downlink control information) transmissions, UCI (uplink control information) transmissions, SCI (sidelink control information) transmissions, another transmission, or a combination thereof.

UE 115 can include a variety of components (e.g., structural, hardware components) used for carrying out one or more functions described herein. For example, these components can include processor 402, memory 404, transmitter 410, receiver 412, encoder, 413, decoder 414, RIS manager 415, RIS configuration evaluator 416, and antennas 252a-r. Processor 402 may be configured to execute instructions stored at memory 404 to perform the operations described herein. In some implementations, processor 402 includes or corresponds to controller/processor 280, and memory 404 includes or corresponds to memory 282. Memory 404 may also be configured to store RIS configuration information 406, RIS acknowledgment information 408, RIS measurement information 442, RIS settings information 444, or a combination thereof, as further described herein.

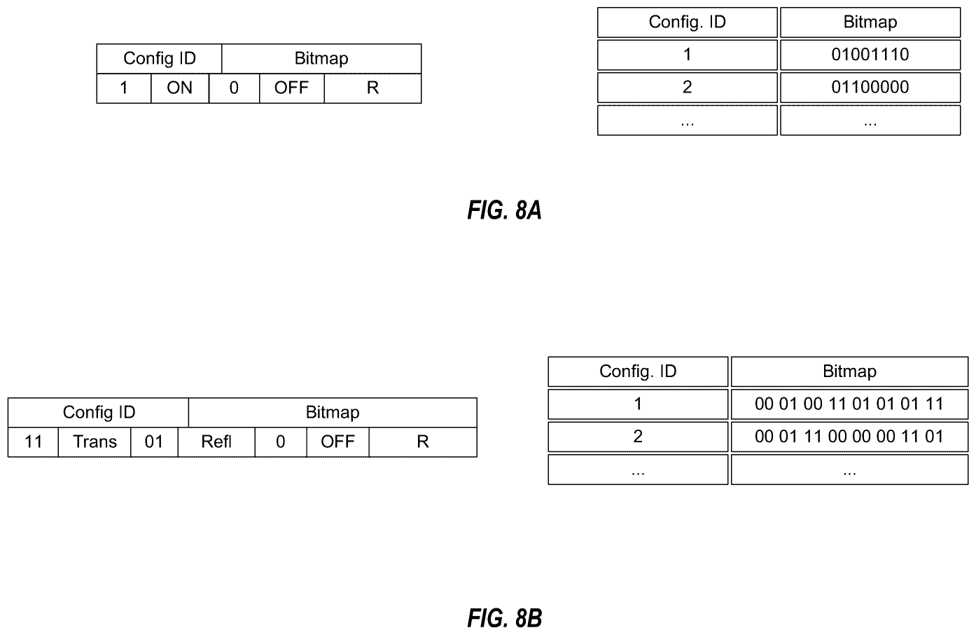

The RIS configuration information 406 includes or corresponds to data associated with RIS configurations of RISs controlled by and/or coupled to a RIS controller. For example, the RIS configuration information 406 may include information on one or more RIS configurations available for a RIS controller, such as a subset of all potential or possible configurations. The RIS configuration information 406 may include or correspond to a file indicating all available or all possible configurations. Additionally, or alternatively, the RIS configuration information 406 may identify or indicate individual RISs associated with the controller (e.g., of the vehicle) and optionally particular states or options for the RISs (e.g., active, reflective, transmissive, off, etc.). Examples of the RIS configuration information 406 are illustrated with respect to FIGS. 8A and 8B.

The RIS acknowledgement information 408 includes or corresponds to data associated with or corresponding to RIS acknowledgement indications for enhanced RIS configuration operations. For example, the RIS acknowledgement information 408 may include acknowledgement indications for beacons from RIS controllers. To illustrate, the RIS acknowledgement information 408 may include positive acknowledgement indications for requesting access, configuration, or reconfiguration of the RIS system, and negative acknowledgement indications for configuration or reconfiguration of the RIS system.

The RIS measurement information 442 includes or corresponds to data associated with measurements of RIS configurations. For example, the RIS measurement information 442 may include or correspond to measurements of RSRP, RSRQ, SINR, RSSI, or a combination thereof. Each measurement may include or correspond to a particular RIS configuration, including no RIS configuration (e.g., all RIS inactive or off). The RIS measurement information 442 may be used, such as compared to, one another and/or one or more thresholds to determine which RIS measurement, and corresponding RIS configuration to select. Additionally, RIS measurements may be used to determine whether to use or engage in RIS configuration, such as when and how to respond to discovery beacons.

The RIS settings information 444 includes or corresponds to data associated with enhanced RIS configuration operations. The RIS settings information 444 may include one or more types of enhanced RIS configuration operation modes and/or thresholds or conditions for switching between enhanced RIS configuration modes and/or configurations thereof. For example, the RIS settings information 444 may have data indicating different thresholds and/or conditions for different RIS configuration modes, such as one device modes, two device modes, or a combination thereof.

In some implementations, the RIS settings information 444 (e.g., RIS settings data) includes RIS configuration settings information. The RIS configuration settings information includes or corresponds to data associated with the timing or scheduling of RIS controller actions and/or RIS configurations. For example, the RIS configuration setting information may include scheduling or timing information for setting a particular RIS configuration, for cycling through or changing a current RIS configuration, for transmitting discovery beacons, for monitoring for responses to discovery beacons, for monitoring for RIS configuration commands, etc. In some implementations, the RIS configuration settings information is indicated by the RIS configuration information 406 or by information in a beacon. In other implementations, the RIS configuration settings information is transmitted separately or preconfigured.

In some implementations, the RIS settings information 444 (e.g., RIS settings data) includes RIS condition information. The RIS condition information includes or corresponds to data associated with evaluating and selecting RIS configurations of a RIS controller. For example, the RIS condition information may include or correspond to a threshold or set of thresholds for determining whether to access a RIS controller, change a RIS configuration, request a RIS reconfiguration, etc. As illustrative examples, the thresholds may include or correspond to signal strength or quality based thresholds (e.g., a particular RSRP level or a particular change in RSRQ level), a timer based threshold (e.g., reconfigure every X ms or cycles), a position threshold (e.g., reconfigure based on a handover event, based on vehicle position or heading change, or based on the UEs position within the vehicle or building changing), or a combination thereof.

In some implementations, the RIS settings information 444 (e.g., RIS settings data) includes RIS access information. The RIS access information includes or corresponds to data associated with access to or control of a RIS controller. For example, the RIS access information may include access key or token information for communicating with a RIS controller. As another example, the RIS access information may include access key or token information for indicating a priority with a RIS controller. In some implementations, the access information includes first access key or token information for securely communicating with the RIS controller and second access key or token information for access priority information. Additionally, or alternatively, the access information may include duration information for a control of the RIS controller or until the RIS controller is available.

Transmitter 410 is configured to transmit data to one or more other devices, and receiver 412 is configured to receive data from one or more other devices. For example, transmitter 410 may transmit data, and receiver 412 may receive data, via a network, such as a wired network, a wireless network, or a combination thereof. For example, UE 115 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 410 and receiver 412 may be replaced with a transceiver. Additionally, or alternatively, transmitter 410 or receiver, 412 may include or correspond to one or more components of UE 115 described with reference to FIG. 2.

Encoder 413 and decoder 414 may be configured to encode and decode data for transmission. RIS manager 415 may be configured to perform enhanced RIS configurations operations, such as RIS operation determinations and signaling operations. For example, RIS manager 415 may be configured to determine whether to engage in RIS based operations. To illustrate, the RIS manager 415 may determine to perform RIS operations, such as to engage in RIS configuration or reconfiguration, based on evaluating one or conditions, such as comparing measurements and/or thresholds, evaluating time based conditions, handover conditions, QoS conditions, etc. As another example, RIS manager 415 may be configured to determine when and how to respond to beacons from the RIS controller 401 and when and how to perform RIS configuration measurements, such as measurements using individual RIS configurations.

RIS configuration evaluator 416 may be configured to perform evaluation of different RIS configurations and/or select which RIS configurations to measure. For example, the RIS configuration evaluator 416 may be configured to determine which RIS configurations by identifying a subset of available RIS configurations to measure or evaluate, such as based on machine learning or artificial interleafing assisted determinations. To illustrate, the RIS configuration evaluator 416 may utilize machine learning or AI algorithms or data sets to identify which RIS configurations of a set RIS configurations of the RIS configuration information 406 to measure. Additionally, or alternatively, the RIS configuration evaluator 416 may be configured to evaluate different RIS configurations and select a particular configuration for the UE 115. To illustrate, the RIS configuration evaluator 416 may compare measurement values to each other and/or thresholds values to determine which RIS configuration to select or whether to select a current RIS configuration.

RIS controller 401 includes processor 430, memory 432, transmitter 434, receiver 436, encoder 437, decoder 438, RIS manager 439, RIS configuration evaluator 440, and antennas 234a-t. Processor 430 may be configured to execute instructions stores at memory 432 to perform the operations described herein. In some implementations, processor 430 includes or corresponds to controller/processor 240, and memory 432 includes or corresponds to memory 242. Memory 432 may be configured to store RIS configuration information 406, RIS acknowledgment information 408, RIS measurement information 442, RIS settings information 444, or a combination thereof, similar to the UE 115 and as further described herein.

Transmitter 434 is configured to transmit data to one or more other devices, and receiver 436 is configured to receive data from one or more other devices. For example, transmitter 434 may transmit data, and receiver 436 may receive data, via a network, such as a wired network, a wireless network, or a combination thereof. For example, UEs and/or RIS controller 401 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 434 and receiver 436 may be replaced with a transceiver. Additionally, or alternatively, transmitter 434 or receiver, 436 may include or correspond to one or more components of UE 115 described with reference to FIG. 2.

Encoder 437, and decoder 438 may include the same functionality as described with reference to encoder 413 and decoder 414, respectively. RIS manager 439 may include similar functionality as described with reference to RIS manager 415. For example, the RIS manager 439 may be configured to perform enhanced RIS configurations operations, such as RIS operation determinations and signaling operations. RIS configuration evaluator 440 may include similar functionality as described with reference to RIS configuration evaluator 416. For example, the RIS configuration evaluator 440 may be configured to determine which RIS configurations to evaluate and/or which configurations to use/configuration adjustments needed to avoid handovers and/or beam switches for or by the UE 115.

Base station 105 may include one or more components of UE 115, RIS controller 401, or both. For example, the base station 105 may include similar components to the RIS controller 401 and be configured to wirelessly communicate on multiple wireless frequency ranges. In some implementations, the RIS controller 401 is a short range, low power, and/or low complexity wireless device with is configured to wirelessly communicate on a single wireless frequency range and/or network. In a particular implementation, the RIS controller is configured to communicate on different wireless network, such as Bluetooth or Wi-Fi, from the base station 105 (e.g., cellular network).

During operation of wireless communications system 400, the network (e.g., base station 105 or RIS controller 401) may determine that UE 115 has enhanced RIS configuration capability. For example, UE 115 may transmit a message 448 that includes an enhanced RIS configuration indicator 490. Indicator 490 may indicate enhanced RIS configuration capability for one or more communication modes, such as downlink, uplink, etc. In some implementations, a network entity (e.g., a base station 105) sends control information to indicate to UE 115 that enhanced RIS configuration operations is to be used or able to be used. For example, in some implementations, configuration transmission 450 is transmitted to the UE 115. The configuration transmission 450 may include or indicate to use enhanced RIS configuration operations or to adjust or implement a setting of a particular type of enhanced RIS configuration operation. For example, the configuration transmission 450 may include a portion of the RIS settings information 444, such as configuration timing or settings data.

During operation, devices of wireless communications system 400, perform enhanced RIS configuration operations. For example, the UE 115 may communicate with external devices and the UE 115 may utilize the RIS controller 401 to adjust RIS configurations to reduce signal path loss, as illustrated in the example of FIG. 4. This enhanced RIS configuration capability and flexibility enables devices to adjust RIS configurations to improve signal quality and strength.

In the example of FIG. 4, the RIS controller 401 transmits a discovery beacon transmission 452 to the UE 115 via a first wireless channel. For example, the RIS controller 401 transmits a first PSSCH to the UE 115 via a sidelink channel, broadcasts a sidelink transmission via a sidelink channel, transmits/broadcasts a Bluetooth beacon transmits/broadcasts a Wi-Fi beacon, or transmits another low power wireless signal. The discovery beacon transmission 452 corresponds to a Bluetooth or Wi-Fi message in the example of FIG. 4, and may be on a separate wireless network from the communications 458 between the UE 115 and the base station 105 on a second wireless network. In other implementations, the discovery beacon transmission 452 may include or correspond to a PSSCH transmission on a first wireless channel separate from the communications 458 between the UE 115 and the base station 105 on a second wireless channel. The discovery beacon transmission 452 may indicate or advertise RIS configuration service or RIS based operations. Discovery beacons may be transmitted periodically by the RIS controller 401, such as once every beacon interval or discovery sequence.

The UE 115 receives the discovery beacon transmission 452 and attempts to decode discovery beacon transmission 452. For example, the UE 115 parses the discovery beacon transmission 452 to determine information regarding the beacon and RIS system or configuration service. The UE 115 may determine that one or more RISs are available for use and/or configuration by the UE 115. Additionally, the UE 115 may determine whether the RIS controller 401 is currently occupied by another device based on the discovery beacon transmission 452 in some implementations, such as by a flag or timer indication in the discovery beacon transmission 452.

The UE 115 transmits a discovery beacon acknowledgement 454 to the RIS controller 401 via the first wireless channel. For example, the UE 115 transmits a response or acknowledgement transmission to the discovery beacon response (also referred to as or discovery beacon acknowledgement or discovery beacon response) to the RIS controller 401 via Bluetooth or Wi-Fi including RIS acknowledgement information 408 for the discovery beacon transmission 452. The RIS acknowledgement information 408 may include or indicate a positive or negative acknowledgement to the discovery beacon transmission 452. The discovery beacon acknowledgement 454, such as the RIS acknowledgment information 408 thereof, may indicate a request to access the RIS controller 401 and/or a request subscribe to the RIS system. The RIS acknowledgment information 408 may indicate a request for information regarding RIS configurations, a request to evaluate RIS configurations, or a request to change a RIS configuration. To illustrate, a positive acknowledgement indication may indicate the beacon was received and that configuration (or reconfiguration) is requested.

The RIS controller 401 transmits a RIS configuration transmission 456 to the UE 115 via the first wireless channel. For example, the RIS controller 401 transmits RIS configuration information 406 to the UE 115 via Bluetooth or Wi-Fi responsive to the discovery beacon acknowledgement 454. To illustrate, the RIS controller 401 may determine to transmit the RIS configuration information 406 based on the RIS acknowledgment information 408 of the discovery beacon acknowledgement 454. As described above, the RIS configuration information 406 may indicate one or more RIS configurations for selection and/or evaluation/measurement by the UE 115. The RIS configuration information 406 may also indicate timing information for the RIS configurations or a currently configured RIS configuration.

The UE 115 and the base station 105 may communicate with each other on a second wireless channel or a second wireless network difference from the first wireless channel and network of the transmissions with the RIS controller 401. For example, the base station 105 and the UE 115 may transmit and receive transmissions via a cellular communication link. To illustrate, the base station 105 may transmit downlink transmissions to the UE 115 and receive uplink transmissions from the UE 115.

The communications between the base station 105 and the UE 115 may be used by the UE 115 to evaluate one or more RIS configurations indicated by the RIS configuration information. For example, the base station 105 may periodically transmit reference signals, and the UE 115 may monitor for the reference signals and perform measurements on the reference signals. To illustrate, the base station 105 may transmit SSB transmissions once every period, and the RIS controller 401 may be configured or preset to change RIS configurations once every period to enable a UE 115 to monitor and measure a new SSB transmission with a new RIS configuration. As another example, the UE 115 may perform measurements on data or other control transmissions and coordinate with the RIS controller 401 to change the RIS configuration after the UE 115 has had sufficient time to perform measurements using the RIS configuration. The UE 115 may calculate RSRP, RSRQ, SINR, etc., based on the measurements.

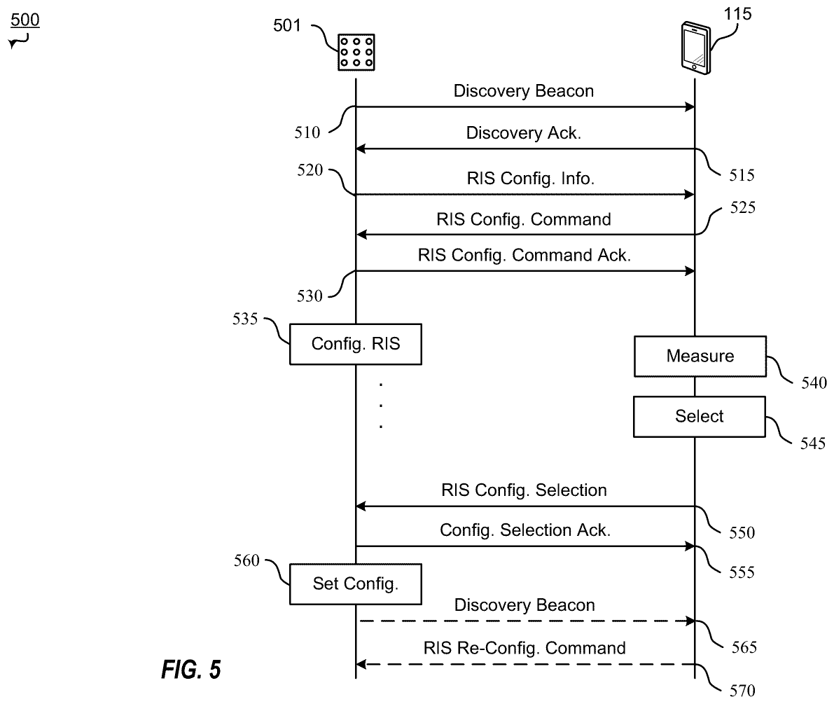

The UE 115 may select a RIS configuration based on the measurement (e.g., RIS measurement information 442) and optionally, one or more conditions or thresholds (such as of the RIS settings information 444). The UE 115 may indicate the selection to the RIS controller 401 for further use. After indication of the selection and configuration thereof, the UE 115 may transmit or receive other communications of the communications 458 (e.g., data communications) using the selected RIS configuration which reduces signal path loss. Further details on RIS selection and indication to the RIS controller are described further with reference to FIGS. 5-7.

The base station 105 may be out of range of the RIS controller 401. However, one or more of the RISs of the vehicle or building and associated with the RIS controller 401 may be in a signal path between the UE 115 and the base station 105 and may reflect or refract signals to reduce a signal strength or quality. The RISs may be able to be adjusted to reduce this interference/impairment and to create additional signal paths between the UE and the base station 105 by redirecting the communications 458.

Accordingly, the network (e.g., the base station 105 and the UE 115) may be able to more efficiently and effectively communicate using RISs through enhanced RIS configuration operations. Improved signal paths through enhanced RIS configuration operations may increase throughput and reduce latency, which may lead to reduced link failures. Accordingly, the network performance and experience may be increased due to the increases in speed and reductions in failure.

Referring to FIG. 5, FIG. 5 is a timing diagram 500 illustrating a wireless communication system that supports RIS configuration according to one or more aspects. The example of FIG. 5 corresponds to an example of RIS configuration for a single device. Additionally, the example operations of FIG. 5 support RIS configurations where a UE may perform a plurality of measurements on a plurality of RIS configurations.

The example of FIG. 5 includes similar devices to the devices described in FIGS. 1, 2, and 4, such as a UE 115 and a RIS controller 501 (e.g., a RIS controller 401). The UE 115 may communicate with other entities via RIS(s) (e.g., 304) of a vehicle (e.g., 302), such as a network entity (e.g., base station 105) or another UE. The devices of FIG. 5 may include one or more of the components as described in FIGS. 2 and 4. In FIG. 5, these devices may utilize antennas 252a-r, transmitter 410, receiver 412, encoder 413 and/or decoder 414, or may utilize antennas 234a-t, transmitter 434, receiver 436, encoder 437 and/or decoder 438 to communicate and receive transmissions in accordance with RIS configuration and utilizing RIS.

At 510, RIS controller 501 transmits a beacon to the UE 115. For example, the RIS controller 501 broadcasts a discovery beacon regarding RIS configuration or advertising RIS services. The beacon may indicate or advertise a RIS configuration service and/or configuration of one or more RISs. The beacon may be used as a discovery beacon for new devices and/or devices without an active RIS configuration, and may be used as reconfiguration beacon or reconfiguration solicitation for a device or devices which have previously associated with the RIS controller 501, and which may optionally have an active RIS configuration. The RIS controller 501 may transmit a beacon periodically, such as once in every x milliseconds or beacon/discovery interval, and the RIS controller 501 may listen to a wireless channel for a time (e.g., T_b) after the transmission of the beacon. The RIS controller 501 may have a preset or configuration discovery sequence regarding when and on which channel the RIS controller 501 transmits the beacons and listens for responses.

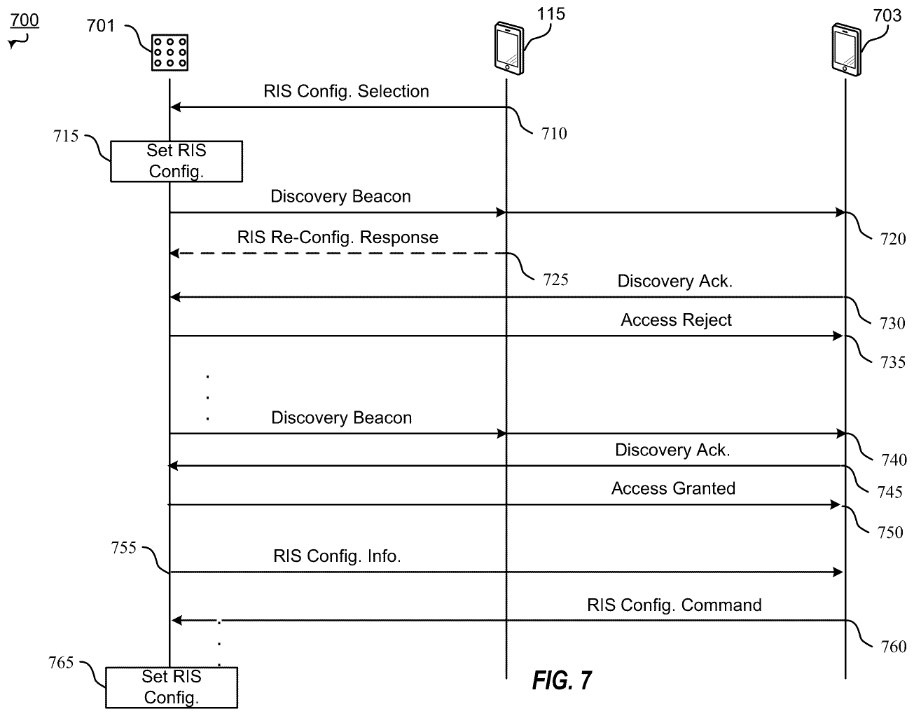

The beacon may be utilized for multiple uses. For example, a new UE will use the beacon as a discovery signal, while a previously connected UE may use the beacon to inform to indicate if reconfiguration is required, such as based on channel measurement. If multiple UEs attempt to use the RIS system, they may use it in a subscription-based access protocol where only one UE has the exclusive right to modify the RIS configuration for a period of time. Examples of multiple UE operations are described further with reference to FIG. 7.

If no response is received to a beacon, such as when there is no device attempting to access the RIS controller 501 or there is no reconfiguration required, the RIS controller 501 can go to sleep mode until it needs to send the next beacon.

At 515, the UE 115 receives the beacon and transmits a response to the RIS controller 510 responsive to the beacon. For example, the UE 115 receives the discovery beacon and transmits a discovery acknowledgement to the RIS controller 510 responsive to the discovery beacon. To illustrate, the UE 115 transmits a response to the discovery beacon, a discover acknowledgement transmission or message including acknowledgement information (e.g., beacon acknowledgement information or configuration request information) to enable RIS configuration. In some implementations, transmission of the discovery acknowledgment indicates a RIS configuration operation or transmission of RIS configuration information.

The UE 115 may determine whether to respond to the discovery beacon based on one or more conditions, such as a current RSRP, SINR, RSSI, etc., of communications with other devices, a QoS of the communications with other devices, error rate of current communications, a handover condition, etc.

When a UE misses a beacon after association (e.g., responding to a first beacon or successfully obtaining access to the RIS controller 501), there will be no beacon response and the UE may continue to monitor for subsequent beacons. As described further herein, subsequent beacons may be used to indicate if reconfiguration is requested and optionally if the UE is active. To illustrate, a subsequent beacon acknowledgment may indicate a first value, such as 0, when no reconfiguration is requested, and a second value, such as 1, when reconfiguration is requested. If the UE is not active anymore (e.g., out of the vehicle, switched off, etc.), there will be no responses to beacons (e.g., no reconfiguration update message) or the responses may have an invalid value. The RIS controller 501 may monitor for a lack of responses to discovery beacons and/or invalid values to enable another UE to access the RIS system.

At 520, the RIS controller 501 transmits RIS configuration information to the UE 115 responsive to the discovery acknowledgement. For example, the RIS controller 501 may receive the acknowledgement information and transmit a response including RIS configuration information to enable the UE 115 to engage in RIS configuration selection, such as RIS configuration measurement and evaluation.

This RIS configuration information may include or indicate one or more configuration identifiers (e.g., RIS conFIG. IDs or simply RIS ID) associated with the available RIS configurations. The UE 115 may then use the one or more configuration identifiers (e.g., RIS configuration index values) for RIS-based link measurements and to select the RIS configuration. To illustrate, the UE 115 may associate measurements and selections with the RIS IDs.

In some implementations, the RIS configuration information may include a bitmap indicating the available RISs and/or the available RIS configurations. For example, the bitmap may be associated with a particular RIS configuration identifier and indicate the settings of each individual RISs of the system. In some implementations, all potential RIS combinations of individual configurations may not be possible or have an active configuration. To illustrate, a configuration may not exist where each RIS is set to active as such may not be a practical or useful combination of RIS settings.

The RIS configuration information may optionally include scheduling/timing information (e.g., RIS configuration timing information) for configuration of one or more RISs. For example, the RIS controller 501 may transmit the scheduling information indicating when the RIS controller will change or cycle through RIS configurations and a starting RIS configuration or indicating a timing for each RIS configuration. Alternatively, the scheduling/timing information may be included in the discovery beacon or a subsequent transmission from the RIS controller, such as the RIS configuration command acknowledgement. In some other implementations, the scheduling/timing information for configurations may be determined by the UE 115, such as based on SSB timing of the network, and may be indicated to the RIS controller, such as in the RIS configuration command.

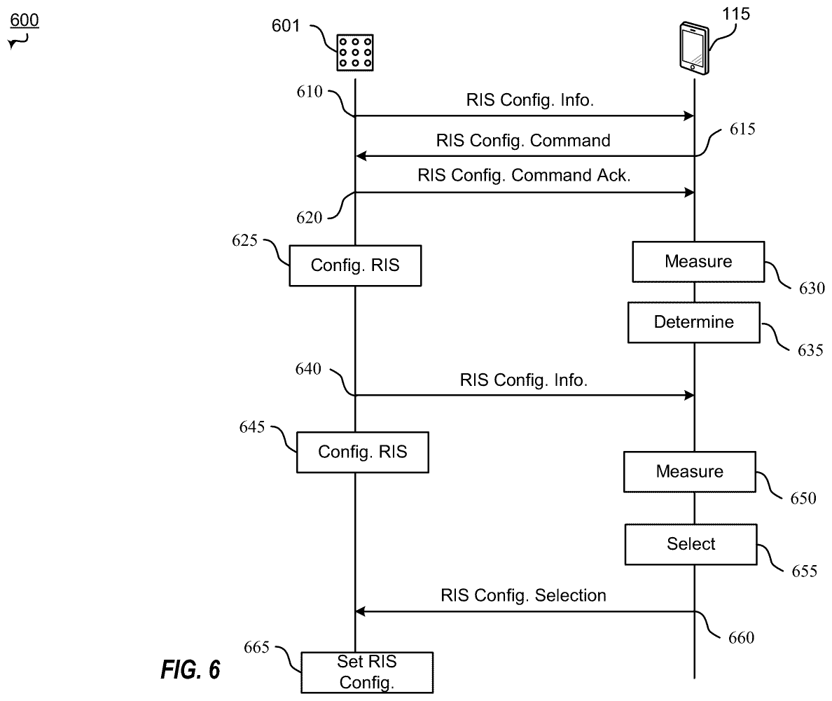

The RIS configuration information may be sent in a single message, such as in the example of FIG. 5, or may be sent in multiple transmissions, such as in the example of FIG. 6. When sent in one message, the RIS configuration information may include or correspond to a RIS configuration file. When sent in multiple transmissions each RIS configuration message corresponding RIS configuration information (e.g., partial RIS configuration information) may indicate a single RIS configuration or a subset of RIS configurations of the available or potential RIS configuration.

When multiple or all configurations are sent in a single transmission, such as in the example of FIG. 5, the RIS configurations may include two option RIS configurations, e.g., off and on for individual RIS, or may include more than two options, e.g., Transmissive, Reflective and off.

At 525, the UE 115 transmits a RIS configuration command. For example, the UE 115 may receive the RIS configuration information and transmit a response indicating a command or request to perform RIS configuration selection (e.g., RIS configuration measurement). In some implementations, the UE 115 receives and parse the RIS configuration information indicating RIS configurations and/or timings to determine or identify RIS scheduling information and provides timing information and/or specific RIS configurations to be tested during RIS configuration selection. In some such implementations, such as when the RIS configuration information includes information identifying the individual RIS settings of the RIS configurations, the UE 115 may determine, such as by machine learning or artificial intelligence, which configurations to test or which configurations to prioritize and test first.

At 530, the RIS controller 501 optionally transmits RIS configuration command acknowledgement to the UE 115 based on the RIS configuration command. For example, the RIS controller 501 transmits a message confirming the RIS configuration command or setting indicated in the RIS configuration command from the UE 115 and based on the command. In some implementations, the RIS configuration command acknowledgement indicates timing information for the measurements and/or the individual RIS configurations to be tested, such as by confirming a RIS configuration setting identified in the RIS configuration command.

At 535, the RIS controller 501 configures one or more RISs of the vehicle. For example, the RIS controller 501 may transmit one or more control signals to RISs of the vehicle to adjust the RIS for specific configurations based on the RIS configuration command, the RIS configuration acknowledgement, or both. In some implementations, the RIS controller 501 may cycle through a plurality of RIS configurations periodically so that the UE 115 can measure the RIS configurations. For example, the RIS controller 501 may periodically change RIS configurations every X duration which coincides with a particular transmission from a base station, such as SSB transmissions, to enable the UE 115 to measure each RIS configuration with a different SSB transmission.

At 540, the UE 115 performs one or more measurement operations. For example, the UE 115 may communicate with a third device, such as a base station or another UE, using the RIS configuration and one or more RISs of the vehicle. To illustrate, the UE 115 may monitor a RSSI, RSRP, RSRQ, etc. of SSB transmission from a base station 105 and compare the measurements to a threshold and/or to measurement(s) from other RIS configurations.

At 545, the UE 115 selects a particular RIS configuration of a plurality of RIS configurations. For example, the UE 115 compares a plurality of measurement to each other to select the highest measurement and compares the highest measurement to a threshold. If the highest measurement is greater than or equal to the threshold, the UE 115 may select the configuration for continued use. The threshold may include or correspond to a preset threshold or correspond to a previous (e.g., most recent) measurement without using any RIS configuration or with using a default RIS configuration. As another example, the UE 115 may select a RIS configuration with a highest value and independent of a threshold condition. As yet another example, the UE may select a first configuration which exceeds a previous measurement or measurement with a default RIS configuration (e.g., all RIS inactive) by a threshold amount. In some implementation, the UE 115 may compare measurements to each other and to a threshold to select a highest measurement which exceeds a threshold measurement value, or which exceeds a minimum improvement value from a measurement prior to RIS configuration.

At 550, the UE 115 transmits a RIS configuration selection transmission to the RIS controller 501. For example, UE 115 transmits a RIS configuration selection information or second RIS configuration command information indicating a selection of a RIS configuration to the RIS controller 501. The RIS configuration selection transmission may indicate the RIS configuration by explicitly, such as by a RIS ID or an adjustment to a particular RIS, or implicitly, such as by time (e.g., during period x) or by measurement number (e.g., second measured RIS configuration), both of which may be associated with a particular RIS configuration at the RIS controller 501.

At 555, the RIS controller 501 transmits a RIS configuration selection acknowledgment transmission to the UE 115 based on the RIS configuration selection transmission. For example, the RIS controller 501 transmits an acknowledgment to the RIS configuration selection transmission to the UE 115 based on the RIS configuration selection transmission.

At 560, the RIS controller 501 sets the RIS configuration indicated by the UE 115. For example, the RIS controller 501 receives the RIS configuration selection transmission and parses the transmission to determine RIS configuration selection information indicating a particular selected RIS configuration. The RIS configuration selection information may indicate a particular RIS configuration of the RIS configuration information or indicate an adjustment to a particular RIS configuration (e.g., adjust RIS #2 to transparent for RIS configuration ID #4). The RIS controller 501 may transmit one or more control signals to the RISs of the vehicle to adjust one or more RIS and implement the selected RIS configuration.

After 560 and once the configuration is set, the UE 115 may communicate with one or more other devices using the RIS configuration set by the RIS controller 501. For example, the UE 115 may transmit and receive transmissions with a base station (e.g., base station 105) via a signal path that includes transmission or reflection by at least one RIS controlled by the RIS controller 501. Additionally or alternatively, the UE 115 may transmit and receive transmission with another UE via a second signal path that includes transmission or reflection by at least one RIS controlled by the RIS controller 501. In some such implementations, the RIS configuration may improve signal strength for one communication link (e.g., one direction or with one specific device) and may not improve or degrade signal strength with another communication link (e.g., another direction or with another specific device). In such implementations, the UE 115 may reconfigure the RISs of the vehicle via the additional operations with the RIS controller.

Optionally, the UE 115 and RIS controller 501 may perform one or more RIS configuration operations after 560. For example, the UE 115 may periodically evaluate or re-evaluate the selected RIS condition. To illustrate, the UE 115 may measure signal strength of received transmission (e.g., data and/or control transmissions) to determine whether to change or re-configure the RIS of the vehicle. As an illustrative example, the UE 115 may determine to change a RIS configuration based on one or more of, a change in direction, a change in signal strength above a thresholds, a signal strength lower than or equal to a threshold, a timer condition, receiving a change indication/request from the other device (e.g., the RIS controller or a second UE). After determining to change the RIS configuration, the UE 115 and RIS controller 501 may perform similar steps from 510-560.

As an example illustration of performing additional configurations, the RIS controller 501 may transmit a second discovery beacon at 565. The second discovery beacon may be the same as or different from the discovery beacon (first discovery beacon) at 510. In some implementations, the discovery beacon is the same and the UE 115 may respond differently based on already discovering the RIS controller 501 and/or having an active configuration with. For example, the UE 115 may treat the discovery beacon as a change request message (reconfiguration request message) or beacon and respond to the beacon to indicate whether a change in the RIS configuration is needed. To illustrate, at 570, the UE 115 transmit a second beacon response message indicating an acknowledgement to the second discovery beacon. The acknowledgement (e.g., second acknowledgement) may indicate an acknowledgement (e.g., positive acknowledgement or ACK) indicating to reconfigure the RIS configuration or (e.g., negative acknowledgement or NACK) indicating not to reconfigure the RIS configuration. When the second beacon response message includes the positive acknowledgment, the second beacon response message may include or correspond to a RIS re-configuration command indicating whether or not to reconfigure the RIS configuration. An example of configuring a RIS controller for multiple UEs is described further with reference to FIG. 7.

In the example of FIG. 5, the operations may enable partially blind configuration of RIS configurations. That is, a UE may not be aware what that actual settings of each RIS are of the RIS configuration. In some such implementations, the RIS configuration information may not include a bitmap indicating the specific RIS configurations of each RIS. Rather, only RIS configuration related information, such as a RIS ID, may be included in the RIS configuration information. In the operations of the example of FIG. 5, the UE may not even need or receive RIS bitmap information as the RIS controller as the UE can identify a measured configuration by timing and index information (e.g., RIS configuration ID).

Accordingly, in the example, of FIG. 5, devices within a vehicle or building with RISs may be able to communicate with a corresponding RIS controller to adjust one or more of the RISs to improve signal propagation through the vehicle or building. Additionally, the device may be able to reconfigure the one or more RIS as the device moves within the building or vehicle, or as the vehicle moves around. Enhanced configuration of RISs increases throughput and reduces latency and errors by reducing signal path loss.

Referring to FIG. 6, FIG. 6 is a timing diagram 600 illustrating a wireless communication system that supports RIS configuration according to one or more aspects. The example of FIG. 6 corresponds to an example of RIS configuration for a single device with serial configuration and measurement operations.

The example of FIG. 6 includes similar devices to the devices described in FIGS. 1, 2, 4, and 5, such as a UE 115 and a RIS controller 601 (e.g., a RIS controller 401 or 501). The UE 115 may communicate with other entities via RIS(s) (e.g., 304) of a vehicle (e.g., 302), such as a network entity (e.g., base station 105) or another UE. The devices of FIG. 6 may include one or more of the components as described in FIGS. 2 and 4. In FIG. 6, these devices may utilize antennas 252a-r, transmitter 410, receiver 412, encoder 413 and/or decoder 414, or may utilize antennas 234a-t, transmitter 434, receiver 436, encoder 437 and/or decoder 438 to communicate and receive transmissions in accordance with RIS configuration and utilizing RIS.

Prior to 610, the UE 115 and the RIS controller 601 may optionally engage in one or more operations as described with reference to FIG. 5. For example, the RIS controller 601 may broadcast discovery beacons and receive a response to the discovery beacon from the UE 115, as described with reference to FIG. 5.

At 610, the RIS controller 601 transmits RIS configuration information to the UE 115. The RIS controller 601 transmitting the RIS configuration information may include or correspond to transmitting the RIS configuration information at 520 of FIG. 5. As compared to the operations in FIG. 5, the RIS configuration information may not include RIS configuration details for settings of individual RISs of the system (e.g., bitmap information) in some examples. To illustrate, the UE 115 may perform blind configuration and/or serially perform measurements responsive to dedicated per configuration signaling from the RIS controller 601. In such operations, the UE 115 need not know the actual details of the RIS configuration or even the RIS ID, rather the UE 115 will be evaluating a currently selected RIS configuration.

At 615, the UE 115 transmits a RIS configuration command to the RIS controller 601. The UE 115 transmitting the RIS configuration command may include or correspond to transmitting the RIS configuration command at 525 of FIG. 5.

At 620, the RIS controller 601 optionally confirms the RIS configuration command or the RIS configuration setting. For example, the RIS controller 601 optionally a RIS configuration command acknowledgement to the UE 115 based on the RIS configuration command from the UE 115. The RIS controller 601 transmitting the RIS configuration command acknowledgement may include or correspond to transmitting the RIS configuration command acknowledgement at 530 of FIG. 5.

At 625, the RIS controller 601 sets a first RIS configuration responsive to the RIS configuration command from the UE 115. For example, the RIS controller 601 may set an indicated RIS configuration from the UE 115 or the RIS configuration sent in the RIS configuration information at 610. The RIS configuration set may correspond to a particular indicated configuration of RISs from a set of RIS configurations or a RIS configuration set by the RIS controller 601. The RIS controller 601 setting the RIS configuration may include or correspond to setting the RIS configuration at 535 of FIG. 5. In some such implementations, the RIS controller 601 selects the RIS configuration based on or assisted by a machine learning algorithm.

At 630, the UE 115 performs a measurement operation for the RIS configuration. For example, the UE 115 may communicate with a third device, such as a base station or another UE, using the RIS configuration set at 624 and one or more RISs of the vehicle. To illustrate, the UE 115 may monitor a RSSI, RSRP, SINR, RSRQ, etc. of a SSB transmission from a base station 105 and compare the measurement to a threshold and/or to a measurement from one or more other RIS configurations. The UE 115 performing a measurement operation may include or correspond to performing a measurement operation at 540 of FIG. 5.

At 635, the UE 115 evaluates the RIS configuration and determines whether to set the RIS configuration. For example, the UE 115 compares the current measurement for a current RIS configuration to a threshold. If the measurement is greater than or equal to the threshold, the UE 115 may select the configuration for continued use. The threshold may include or correspond to a preset threshold or correspond to a previous (e.g., most recent) measurement without using any RIS configuration or with using a default RIS configuration. As the UE 115 may engage in serial evaluation of RIS configurations, the UE 115 may compare the measurement only to a threshold and not to previous or other measurements.

As another example, the UE 115 compares the current measurement to a previous measurement (e.g., a measurement before RIS configuration or of a previous RIS configuration) to select the highest measurement and compares the highest measurement to a threshold. If the highest measurement is greater than or equal to the threshold, the UE 115 may select the configuration for continued use. The UE 115 evaluating a RIS configuration may include or correspond to evaluating a RIS configuration at 545 of FIG. 5.

At 640, the RIS controller 601 optionally transmits second RIS configuration information to the UE 115. For example, the RIS controller 601 transmits second RIS configuration information to the UE 115 indicating a second configuration and measurement responsive to not receiving a RIS configuration selection message or responsive to receiving a second RIS configuration command (not shown). The RIS controller 601 transmitting the second RIS configuration information may include or correspond to transmitting the RIS configuration information at 520 of FIG. 5 or 610 of FIG. 6. Alternatively, the RIS controller my implement the second RIS configuration based on time and independent of dedicated signaling.

After 635, the UE 115 may optionally transmit a second RIS configuration command to the RIS controller 601. For example, the UE 115 transmit the second RIS configuration command to the RIS controller 601 to request an additional measurement based on determining the current measurement did not satisfy a threshold value. The UE 115 may receive the second RIS configuration information in response to the second RIS configuration command. The UE 115 transmitting the RIS configuration command may include or correspond to transmitting the RIS configuration command at 525 of FIG. 5 or 615 of FIG. 6. Additionally, the RIS controller 601 may optionally transmit a second RIS configuration command acknowledgement to the UE 115, as described with reference to 620 of FIG. 6.

At 645, the RIS controller 601 sets a second RIS configuration. For example, the RIS controller 601 may set a second indicated RIS configuration from the UE 115 or the RIS configuration sent in the RIS configuration information at 640. The second configuration may be set based on time, responsive to the second RIS configuration command from the UE 115, or responsive to the second RIS configuration information from the RIS controller 601. The RIS controller 601 setting the RIS configuration may include or correspond to setting the RIS configuration at 535 of FIG. 5 or 625 of FIG. 6.

At 650, performs a second measurement operation for the second RIS configuration. For example, the UE 115 may communicate with a third device, such as a base station or another UE, using the second RIS configuration set at 640 and one or more RISs of the vehicle. To illustrate, the UE 115 may monitor a second RSSI, RSRP, RSRQ, SINR, etc. of a second SSB transmission from a base station 105 and compare the measurement to the threshold and/or to a measurement from one or more other RIS configurations. The UE 115 performing a second measurement operation may include or correspond to performing a measurement operation at 540 of FIG. 5 or 630 of FIG. 6.

At 655, the UE 115 evaluates the second RIS configuration and determines to set the second RIS configuration. For example, the UE 115 determines that the second measurement value meets or exceeds the threshold value. The UE 115 evaluating a RIS configuration may include or correspond to evaluating a RIS configuration at 545 of FIG. 5 or 635 of FIG. 6.

At 660, the UE 115 transmits a RIS configuration selection transmission to the RIS controller 601. For example, UE 115 transmits RIS configuration selection information to the RIS controller 601 indicating the second RIS configuration or to use a currently set RIS configuration based on determining that the second measurement satisfied the threshold condition. The UE 115 transmitting the RIS configuration selection may include or correspond to transmitting the RIS configuration selection at 550 of FIG. 5.

After 660, the RIS controller 601 may optionally transmit a RIS configuration selection acknowledgment transmission to the UE 115 based on the RIS configuration selection transmission, as described with reference to 555 of FIG. 5. For example, the RIS controller 601 may transmit a RIS configuration selection acknowledgment transmission to the UE 115 to confirm or acknowledge the selection.

At 665, the RIS controller 601 sets the second RIS configuration as a selected configuration responsive to the RIS configuration selection transmission (e.g., RIS configuration selection command) from the UE 115. For example, the RIS controller 601 may set the second RIS configuration associated with the RIS configuration selection transmission. Setting the second RIS configuration may include or correspond to refraining from setting another RIS configuration. The RIS controller 601 setting the RIS configuration may include or correspond to setting the RIS configuration at 560 of FIG. 5.

Accordingly, in the example, of FIG. 6, devices within a vehicle or building with RISs may be able to communicate with a corresponding RIS controller to adjust one or more of the RISs to improve signal propagation through the vehicle or building. Additionally, the device may be able to reconfigure the one or more RIS as the device moves within the building or vehicle, or as the vehicle moves around. Enhanced configuration of RISs increases throughput and reduces latency and errors by reducing signal path loss.

As compared to the example of FIG. 5, the example of FIG. 6 may enable fully blind configuration of RIS configurations. That is, a UE may not be aware which RIS configuration is active for a particular measurement and/or what that actual settings of each RIS are of the RIS configuration. In some such implementations, the RIS configuration information may not include a bitmap indicating the specific RIS configurations of each RIS. Rather, only RIS configuration related information may be included in the RIS configuration information. In the operations of the example of FIG. 6, the UE may not even need or receive RIS configuration ID information as the RIS controller and UE perform sequential measurement operations on a single RIS configuration at a time.

Referring to FIG. 7, FIG. 7 is a timing diagram 700 illustrating a wireless communication system that supports RIS configuration according to one or more aspects. The example of FIG. 7 corresponds to an example of RIS configuration for multiple devices. The multiple devices may share access to the RIS controller and/or control over RIS configurations. The devices may operate in a TDMA style and each operate during corresponding time periods with their selected RIS configuration after multiple user RIS configuration. The devices may operate similar to FIG. 5, e.g., RIS configuration by file, or similar to FIG. 6, serial RIS configuration and measurement.

The example of FIG. 7 includes similar devices to the devices described in FIGS. 1, 2, 4, and 5, such as a UE 115 and a RIS controller 701 (e.g., a RIS controller 401, 501, or 601). The UE 115 may communicate with other entities via RIS(s) (e.g., 304) of a vehicle (e.g., 302), such as a network entity (e.g., base station 105) or another UE. The devices of FIG. 7 may include one or more of the components as described in FIGS. 2 and 4. In FIG. 7, these devices may utilize antennas 252a-r, transmitter 410, receiver 412, encoder 413 and/or decoder 414, or may utilize antennas 234a-t, transmitter 434, receiver 436, encoder 437 and/or decoder 438 to communicate and receive transmissions in accordance with RIS configuration and utilizing RIS.

Prior to 710, the UE 115 and the RIS controller 701 may optionally engage in one or more operations as described with reference to FIG. 5 and/or FIG. 6. For example, the RIS controller 701 may broadcast discovery beacons and receive a response to the discovery beacon from the UE 115, as described with reference to FIGS. 5 and 6. The UE 115 and RIS controller 701 may engage in measuring and evaluating one or more RIS configurations.

At 710, the UE 115 transmits a RIS configuration selection transmission to the RIS controller 701. For example, the UE 115 generates RIS configuration selection information based on evaluating one or more measurements of communications with a third party device using at least one RIS configuration. The UE 115 transmitting the RIS configuration selection may include or correspond to transmitting the RIS configuration selection at 550 of FIG. 5 or 660 of FIG. 6.

At 715, the RIS controller 701 sets the RIS configuration as a selected configuration responsive to the RIS configuration selection command from the UE 115. For example, the RIS controller 701 may confirm the RIS configuration. Confirming the RIS configuration may include or correspond to refraining from setting another RIS configuration or confirming a RIS setting of a measurement operation. The RIS controller 701 setting the RIS configuration may include or correspond to setting the RIS configuration at 560 of FIG. 5 or 665 of FIG. 6.

After 715, the UE 115 may utilize the RIS configuration to communicate with one or more other devices, such as devices outside of a vehicle or building including the RIS controller 701. For example, the UE 115 may utilize the RIS configuration to communicate with the base station 105, as in FIG. 4.

At 720, the RIS controller 701 transmits a beacon to the UE 115 and to the second UE 703. For example, the RIS controller 701 broadcasts a discovery beacon regarding RIS configuration or advertising RIS services, similar to as described with reference to 510 of FIG. 5. The beacon may indicate or advertise a service for use and/or configuration of one or more RISs. The beacon may be used as a discovery beacon for new devices and/or devices without an active RIS configuration (e.g., the second UE 703), and may be used as reconfiguration beacon or reconfiguration solicitation for a device or devices with an active RIS configuration (e.g., the UE 115).

At 725, the UE 115 receives the beacon and transmits a response to the RIS controller 710 responsive to the beacon. For example, the UE 115 receives the beacon and transmits an acknowledgement to the RIS controller 710 responsive to the beacon. To illustrate, the UE 115 transmits a response to the beacon, an acknowledgement transmission or message including acknowledgement information indicating one or more of whether to keep a current RIS configuration, release a current configuration transmission, engage in reconfiguration of the RIS configuration, similar to as described with reference to 515 of FIG. 5.

At 730, the second UE 703 receives the beacon (e.g., the “discovery” beacon) and transmits a response to the RIS controller 710 responsive to the beacon. For example, the second UE 703 receives the beacon and transmits a discovery beacon acknowledgement to the RIS controller 710 responsive to the beacon. To illustrate, the second UE 703 transmits a response to the discovery beacon, a discover acknowledgement transmission or message including acknowledgement information (e.g., beacon acknowledgement information or configuration request information) to enable RIS configuration, similar to as described with reference to 515 of FIG. 5.

At 735, the RIS controller 701 transmits a discovery beacon acknowledgement response to the UE 115, the second UE 703, or both. For example, the RIS controller 701 may broadcast a response to one or more of the discovery beacon acknowledgements from the UE 115 and the second UE 703. To illustrate, the RIS controller 701 may broadcast a message indicating two devices are attempting to connect to the RIS controller 701, that the RIS controller is currently configured for or in use by the UE 115 (e.g., configuration by the second UE 115 is temporarily blocked), the current configuration of RIS configuration for potential use by other devices.

As another example, the RIS controller 701 may transmit dedicated messages to one or more of (e.g., each of) the UEs it received beacon responses from. To illustrate, the RIS controller 701 optionally may send a transmission to the UE 115 indicating access granted, configuration permitted, a request to access the RIS controller 701 by another device, an access or subscription duration (e.g., for X number of beacon intervals), or confirming the currently selected configuration or in-process measurement operation, not shown in FIG. 7 for simplicity.

Additionally, or alternatively, the RIS controller 701 may send a transmission to the second UE 703 indicating access rejected, as illustrated in the example of FIG. 7. Similar to the transmission to the UE 115, or the broadcast transmission, the transmission to the second UE 703 may indicate another device currently has or controls access to the RIS controller 701, an access or subscription duration (e.g., for X number of beacon intervals) for the other device, indicate a currently selected configuration or an in-process measurement operation. The transmission may further indicate a token or key for later use by the second UE 703 to gain access to the RIS controller 701. The token or key may include or correspond to an access key and may optionally indicate a priority for the second UE 703 configuring or gaining access to the RIS controller 701.

After 735, the UE 115 may continue to use the RIS configuration to communicate with other devices and may optionally access the RIS controller to configure (e.g., reconfigure) the RIS controller 701 and/or perform measurement operations.

At 740, the RIS controller 701 transmits a second beacon to the UE 115 and to the second UE 703. For example, the RIS controller 701 broadcasts a second discovery beacon regarding RIS configuration or advertising RIS services, similar to as described with reference to 510 of FIG. 5 and 710 of FIG. 7. In the example of FIG. 7, the RIS controller 710 may transmit a plurality of beacons between the beacon at 710 and the second beacon at 740. The second beacon may correspond to a beacon coinciding with a time interval or duration in which the UE 115's access to or control over the RIS controller 710 expires.

At 745, the second UE 703 receives the second beacon (e.g., “discovery” beacon) and transmits a response to the RIS controller 710 responsive to the second beacon, similar as described with reference to 730. For example, the second UE 703 receives the second beacon and transmits a second discovery beacon acknowledgement to the RIS controller 710 responsive to the second beacon. To illustrate, the second UE 703 transmits a response to the discovery beacon, a discover acknowledgement transmission or message including acknowledgement information (e.g., beacon acknowledgement information or configuration request information) to enable RIS configuration, similar to as described with reference to 515 of FIG. 5. In some implementations, such as where an access key or token was previously provided to the second UE 703 by the RIS controller 701, the second UE 703 may include the key or token in the response message or acknowledgement to the second beacon. Although not shown in FIG. 7, the UE 115 may optionally transmit an acknowledgement message to the second beacon, similar as described with reference to 725. The acknowledgement message may indicate release of the RIS controller 701 and/or that no reconfiguration or measurement operations is requested. Alternatively, the UE 115 may be out of range and no longer present.

At 750, the RIS controller 701 transmits a discovery beacon acknowledgement response to the UE 115, the second UE 703, or both. For example, the RIS controller 701 may broadcast a response to one or more of the discovery beacon acknowledgements from the UE 115 and the second UE 703, as described with reference to 735. To illustrate, the RIS controller 701 may broadcast a message indicating two devices are attempting to connect to the RIS controller 701, that the RIS controller is currently configured for or in use by the UE 115 (e.g., configuration by the second UE 115 is temporarily blocked), the current configuration of RIS configuration for potential use by other devices.

As another example, the RIS controller 701 may transmit dedicated messages to one or more of (e.g., each of) the UEs it received beacon responses to, as described with reference to 735. To illustrate, the RIS controller 701 optionally may send a transmission to the UE 115 indicating access granted to another device or that another device currently has or controls access to the RIS controller 701, or an access or subscription duration (e.g., for X number of beacon intervals) for the other device, not shown in FIG. 7 for simplicity.

Additionally, or alternatively, the RIS controller 701 may send a transmission to the second UE 703 indicating access granted, as illustrated in the example of FIG. 7. Similar to the transmission to the UE 115, or the broadcast transmission, the transmission to the second UE 703 may indicate indicating access granted, configuration (reconfiguration) permitted, an access or subscription duration (e.g., for X number of beacon intervals), or indicating the currently selected configuration.

At 755, the RIS controller 701 transmits RIS configuration information to the second UE 703. For example, the RIS controller broadcasts the configuration information or transmits the RIS configuration information to the second UE 703 directly. As described with reference to FIGS. 5-6, the RIS configuration may indicate and/or include information for multiple RIS configurations (e.g., correspond to a configuration file indicating multiple RIS configurations of potential/available configurations), or may correspond to a single RIS configuration. The RIS controller 701 transmitting the RIS configuration information may include or correspond to transmitting the RIS configuration information at 520 of FIG. 5 or 610 of FIG. 6.

At 760, the second UE 703 transmits a RIS configuration command to the RIS controller 701. For example, the second UE 703 transmits the RIS configuration command to the RIS controller 701 to perform one or more RIS measurement operations. The second UE 703 transmitting the RIS configuration command may include or correspond to transmitting the RIS configuration command at 525 of FIG. 5 or 615 of FIG. 6.

The RIS controller 701 may optionally confirm the RIS configuration command or the RIS configuration setting. For example, the RIS controller 701 optionally transmits a RIS configuration command acknowledgement to the second UE 703 based on the RIS configuration command from the second UE 703. The RIS controller 701 transmitting the RIS configuration command acknowledgement may include or correspond to transmitting the RIS configuration command acknowledgement at 530 of FIG. 5 or 620 of FIG. 6.

After 760, the RIS controller 701 and the second UE 703 may engage in RIS configuration as described with reference to FIGS. 4-6. For example, the second UE 703 may measure the effectiveness of different RIS configurations set by the RIS controller 701 may select a particular RIS configuration for use.

At 765, the RIS controller 701 sets a second RIS configuration based on performing the RIS configuration operations with the second UE 703 responsive to the RIS configuration command. For example, the RIS controller 701 may set an indicated RIS configuration from the second UE 703 which was determined based on one or more measurements performed responsive to the RIS configuration command. The RIS configuration set may correspond to a particular indicated configuration of RISs from a set of RIS configurations. The RIS controller 701 setting the RIS configuration may include or correspond to setting the RIS configuration at 535 of FIG. 5 or 665 of FIG. 6.

In the example of FIG. 7, each device may have control or access of the RIS controller 701 and RIS configurations for a particular duration, and the devices share the RIS controller 701 during a duration which lasts multiple beacon intervals. In other implementations, the devices may alternative or control the RIS controller for a single beacon interval. Alternatively, in some implementations, after each UE has a selected RIS configuration, the RIS controller 701 may alternate between the configurations to provide TDMA style access for the UEs simultaneously during a single beacon interval or every other beacon interval.

Accordingly, in the example, of FIG. 7, devices within a vehicle or building with RISs may be able to communicate with a corresponding RIS controller to adjust one or more of the RISs to improve signal propagation through the vehicle or building. Additionally, the device may be able to reconfigure the one or more RIS as the device moves within the building or vehicle, or as the vehicle moves around. Enhanced configuration of RISs increases throughput and reduces latency and errors by reducing signal path loss.

Referring to FIGS. 8A and 8B, FIGS. 8A and 8B illustrate examples of configurations files for RIS configurations. Each RIS configuration may indicate what individual settings each RIS have for a specific configuration. To illustrate, a particular RIS configuration may indicate a first RIS is active, a second RIS is inactive, etc.

In FIGS. 8A and 8B RIS configuration information is illustrated for a system (e.g., vehicle or building) with 7 RISs. In each example, a configuration table or list is provided which associates RIS configurations with a corresponding RIS identifier or index (e.g., RIS ID). The details (settings of the individual RISs) of the RIS configurations may be indicated by a bitmap.

In the example of FIG. 8A, the RIS configurations allow for a two mode RIS. To illustrate, each RIS may have two modes, active and inactive, and each RIS may include or correspond to a transmissive RIS (e.g., refractive) or a reflective RIS.

In some such examples, the configuration file may include one bit for each RIS, such as 1 for active (e.g., reflective or transmissive), 0 for inactive. In a particular implementation, such as for 7 RISs, each configuration of the configuration file is 1 byte and 1 of the bits may be reserved. For other amounts of RISs, each configuration may be smaller or larger. The configuration file may include a plurality of available or possible configurations.

In the example of FIG. 8B, the RIS configurations allow for a more than two mode RIS. To illustrate, one or more of the RISs may have three modes, such as transmissive, reflective, and inactive. For example, one or more of the RISs may correspond to a configurable RIS that can be active in either a transmissive or reflective mode. Additionally, or alternatively, one or more of the RISs may correspond to a configurable RIS that can have multiple modes of a certain category (e.g., transmissive or reflective). To illustrate, a RIS may have a first transmissive (or reflective) setting (e.g., partially transmissive or transmissive at a first angle) and have a second transmissive (or reflective) setting (e.g., fully transmissive or transmissive at a second angle). The configuration file also still supports two or less mode RISs. For example, certain RIS configurations which are not possible, e.g., setting a particular transmissive RIS to a reflective mode, may not be included in as a configuration in the configuration file.

In some such examples, the configuration file may include two bits for each RIS, such as 00 for off, 01 for reflective, 11 for transmissive, 10 for another configuration or reserved. In a particular implementation, such as for 7 RISs, each configuration of the configuration file is 2 bytes and 2 of the bits may be reserved. For other amounts of RISs, each configuration may be smaller or larger. The configuration file may include a plurality of available or possible configurations.

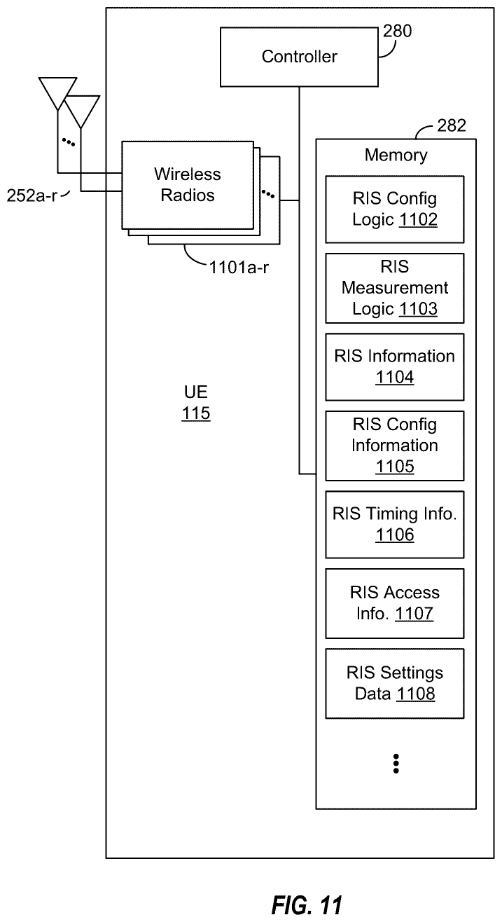

FIG. 9 is a flow diagram 900 illustrating example blocks executed by a wireless communication device (e.g., a UE or base station) configured according to an aspect of the present disclosure. The example blocks will also be described with respect to UE 115 as illustrated in FIG. 11. FIG. 11 is a block diagram illustrating UE 115 configured according to one aspect of the present disclosure. UE 115 includes the structure, hardware, and components as illustrated for UE 115 of FIGS. 2 and/or 4. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 1101a-r and antennas 252a-r. Wireless radios 1101a-r includes various components and hardware, as illustrated in FIG. 2 for UE 115, including modulator/demodulators 254a-r, MIMO detector 256, receive processor 258, transmit processor 264, and TX MIMO processor 266. As illustrated in the example of FIG. 11, memory 282 stores one or more of RIS configuration logic 1102, RIS measurement logic 1103, RIS information 1104, RIS configuration information 1105, RIS timing information 1106, RIS access information 1107, or RIS settings data 1108. The data (1102-1108) stored in the memory 282 may include or correspond to data and/or logic to enable the operations of FIGS. 3A-8B.

At block 902, a wireless communication device, such as a UE or a base station, receive a discovery beacon from a RIS controller of a vehicle. The discovery beacon may include or correspond to one or more of the discovery beacon transmission 452 of FIG. 4, the discovery beacon at 510 or 565 of FIG. 5, or the discovery beacon at 720 or 740 of FIG. 7. For example, the UE 115 receives the discovery beacon transmission 452 from the RIS controller 401.

At block 904, the wireless communication device transmits acknowledgement information in response to the discovery beacon. The acknowledgement information may include or correspond to RIS acknowledgement information 408 of FIG. 4, and/or may be included in the discovery beacon acknowledgement 454 of FIG. 4 or the discovery acknowledgement at 515 of FIG. 5, the reconfiguration command at 570 of FIG. 5, or any of the discovery beacon responses at 725, 730, or 745 of FIG. 7. For example, the UE 115 transmits the discovery beacon acknowledgement 454, including the RIS acknowledgement information 408, to the RIS controller 401.

At block 906, the wireless communication device receives reconfigurable intelligent surface (RIS) configuration information for the vehicle based on the transmission of the acknowledgement information. The RIS configuration information indicates one or more RIS configurations of a plurality of RIS configurations for one or more RISs of the vehicle. The RIS configuration information may include or correspond to the RIS configuration information 406 of FIG. 4 and/or may be included in or correspond to the RIS configuration transmission 456 of FIG. 4, the RIS configuration information transmission at 525 of FIG. 5, the RIS configuration information transmission at 610 or 640 of FIG. 6, or the RIS configuration information transmission at 755 of FIG. 5. The RIS configuration information may indicate one or more RIS configurations of a plurality of RIS configurations for one or more RISs of the vehicle, as described with reference to FIGS. 3A, 3B, 4, 8A, and 8B. For example, the UE 115 may receive RIS configuration transmission 456, which includes the RIS configuration information 406, from the RIS controller 401. Although the example illustrated in FIG. 9 is described with reference to a vehicle, in other implementations, the RIS controller may be included in or associated with a building or other structure which may include one or more RISs and may house or contain one or more UEs within.

The wireless communication device (e.g., UE or base station) may execute additional blocks (or the wireless communication device may be configured to further perform additional operations) in other implementations. For example, the wireless communication device may perform one or more operations described above, such as described with reference to FIGS. 3A-8B. As another example, the wireless communication device may perform one or more aspects as presented below.

In a first aspect, the RIS configuration information indicates a RIS configuration for a single RIS configuration of the plurality of RIS configurations of the vehicle.

In a second aspect, alone or in combination with the first aspect, the RIS configuration information indicates RIS configurations for multiple RIS configurations of the plurality of RIS configurations of the vehicle.

In a third aspect, alone or in combination with one or more of the above aspects, the RIS configuration information comprises RIS configuration index information for a single RIS configuration of the plurality of RIS configurations of one or more RISs of the vehicle and RIS settings information corresponding to the single RIS configuration.

In a fourth aspect, alone or in combination with one or more of the above aspects, the RIS configuration information further includes RIS configuration timing information corresponding to the single RIS configuration.

In a fifth aspect, alone or in combination with one or more of the above aspects, the RIS configuration information comprises RIS configuration index information for multiple RIS configurations of one or more RISs of the vehicle and RIS settings information corresponding to the multiple RIS configurations.

In a sixth seventh aspect, alone or in combination with one or more of the above aspects, the RIS configuration information further includes RIS configuration timing information corresponding to the multiple RIS configurations.

In a seventh aspect, alone or in combination with one or more of the above aspects, the RIS configuration index information indicates an identifier for each RIS configuration of the vehicle included in the RIS configuration information, and wherein the RIS settings information comprises a bitmap indicating configuration settings of each RIS of the vehicle.

In an eighth aspect, alone or in combination with one or more of the above aspects, the at least one processor is further configured to cause the device to: transmit RIS configuration command information based on the RIS configuration information; and perform one or more measurement operations on transmissions received from a second device based on the RIS configuration information and responsive to the transmission of the RIS configuration command information.

In a ninth aspect, alone or in combination with one or more of the above aspects, the at least one processor is further configured to cause the device to: transmit a RIS configuration command based on the RIS configuration information; receive a RIS configuration confirmation message based on the transmission of the RIS configuration command; and perform one or more measurement operations on transmissions received from a second device (e.g., base station or RIS controller, such as a downlink transmission received via a RIS of the vehicle) using one or more RIS configuration.

In a tenth aspect, alone or in combination with one or more of the above aspects, the at least one processor configured to cause the device to perform the one or more measurement operations includes to: perform a plurality of measurements responsive to the RIS configuration confirmation message, each measurement corresponding to a particular transmission from the second device and using a particular RIS configuration of the plurality of RIS configurations indicated by the RIS configuration information; select a RIS configuration from among the plurality of RIS configurations based on comparisons of the plurality of measurements; and transmit an indication of the particular selected RIS configuration to the RIS controller configured to cause the RIS controller to set the selected RIS configuration as a final configuration.

In an eleventh aspect, alone or in combination with one or more of the above aspects, the at least one processor configured to perform the plurality of measurements includes to: perform measurements on Synchronization Signal Block (SSB) transmissions from a base station which are redirected by one or more RISs of the vehicle (e.g., configurations are set to change based on SSB timing).

In a twelfth aspect, alone or in combination with one or more of the above aspects, the at least one processor configured to perform measurements on SSB transmissions includes to: perform a first measurement on a first SSB transmission from the base station using a first RIS configuration of the RIS configuration information; and perform a second measurement on a second SSB transmission from the base station using a second RIS configuration of the RIS configuration information.

In a thirteenth aspect, alone or in combination with one or more of the above aspects, the at least one processor configured to select the RIS configuration includes to: compare the first measurement to the second measurement; and select the first RIS configuration based on determining the first measurement is greater than the second measurement.

In a fourteenth aspect, alone or in combination with one or more of the above aspects, the first measurement corresponds to a received signal strength indicator (RSSI), a reference signal received power (RSRP), a reference signal received quality (RSRQ), or a signal to interference plus noise ratio (SINR).

In a fifteenth aspect, alone or in combination with one or more of the above aspects, the at least one processor configured to cause the device to perform the one or more measurement operations includes to: perform a first measurement responsive to the RIS configuration confirmation message; receive a second RIS configuration confirmation message based on the transmission of the RIS configuration command; perform a second measurement responsive to the second RIS configuration confirmation message.

In a sixteenth aspect, alone or in combination with one or more of the above aspects, the at least one processor configured to cause the device to select the RIS configuration (e.g., the selected RIS configuration) includes to: compare the first measurement to a threshold; determine to keep evaluating RIS configurations based on the first measurement not satisfying the threshold; compare the second measurement to the threshold; determine to select a RIS configuration associated with the second measurement based on the second measurement satisfying the threshold; and transmit an indication to the RIS controller configured to cause the RIS controller to set the RIS configuration associated with the second measurement as a selected RIS configuration.

In a seventeenth aspect, alone or in combination with one or more of the above aspects, the at least one processor is further configured to cause the device to: receive a second discovery beacon from the RIS controller, wherein the second discovery beacon is successfully received and decoded; determine whether to change a current RIS configuration based measurement information; and transmit second acknowledgement information indicating a negative acknowledgement in response to the successful receipt and decoding of the second discovery beacon and based on a determination to not change the RIS configuration.

In an eighteenth aspect, alone or in combination with one or more of the above aspects, the at least one processor is configured to cause the device to: receive a second discovery beacon from the RIS controller, wherein the second discovery beacon is successfully received and decoded; determine whether to change a current RIS configuration based measurement information; and transmit second acknowledgement information indicating a positive acknowledgement in response to the successful receipt and decoding of the second discovery beacon and based on a determination to change the RIS configuration.

In a nineteenth aspect, alone or in combination with one or more of the above aspects, the at least one processor configured to determine whether to change the current RIS configuration based measurement information includes to: determine that a measured parameter is less than or equal to a RIS reconfiguration threshold; determine that a change in a measured parameter is less than or equal to a RIS reconfiguration change threshold; determine that a direction of the vehicle has changed; determine that the device has moved positions within the vehicle; determine that a handover has occurred; or determine that a RIS configuration timer has elapsed.

In a twentieth aspect, alone or in combination with one or more of the above aspects, the at least one processor is configured to: transmit a second RIS configuration command based on the determination to change the RIS configuration and optionally the RIS configuration information or second RIS configuration information; receive a second RIS configuration confirmation message based on the transmission of the second RIS configuration command; perform one or more second measurement operations on second transmissions received from a second device; select a second RIS configuration based on the one or more second measurements; and transmit a second RIS configuration selection based on the selected second RIS configuration.

In a twenty-first aspect, alone or in combination with one or more of the above aspects, the at least one processor is configured to cause the device to: monitor for a second discovery beacon from the RIS controller, wherein the second discovery beacon is not successfully received or decoded; and transmit second acknowledgement information indicating a negative acknowledgement in response to not successfully receiving or decoding the second discovery beacon.

In twenty-second aspect, alone or in combination with one or more of the above aspects, the at least one processor is configured to cause the device to: receive access rejection information in response to the transmission of the acknowledgement information; receive a second discovery beacon from the RIS controller; and transmit second acknowledgement information in response to the second discovery beacon, wherein the RIS configuration information is received responsive to the transmission of the second acknowledgement information.

In a twenty-third aspect, alone or in combination with one or more of the above aspects, the access rejection information indicates a remaining duration for another device associated with the RIS controller.

In a twenty-fourth aspect, alone or in combination with one or more of the above aspects, the access rejection information indicates future access information (e.g., access token or key) in response to the transmission of the acknowledgement information, and wherein the second acknowledgement information indicates the future access information.

Accordingly, wireless communication devices may perform enhanced RIS configuration operations to reduce signal path loss and improve signal strength and quality. Reducing signal path loss may reduce transmission errors and processing latency and enable reduced power consumption, which may lead to better network operations. Accordingly, the network performance and experience may be increased due to reductions in latency, errors, and power consumption.

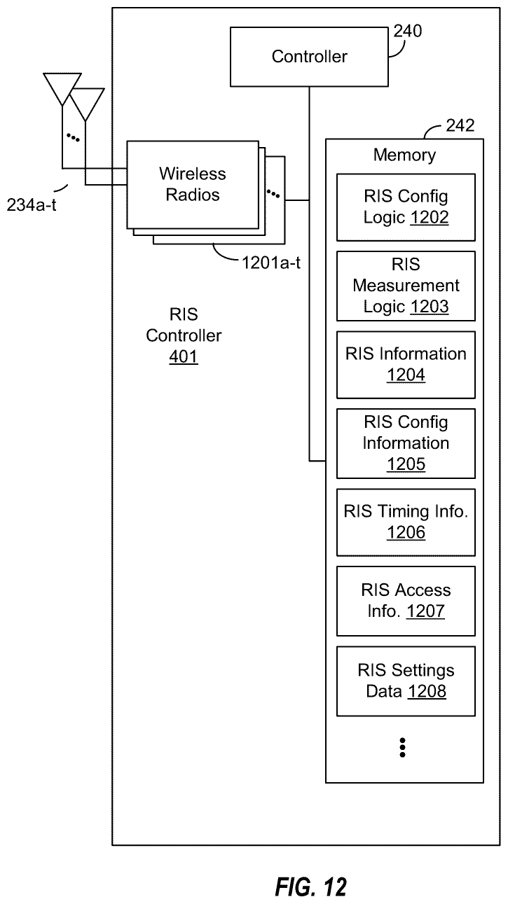

FIG. 10 is a flow diagram 1000 illustrating example blocks executed by a wireless communication device (e.g., a RIS controller, a UE, or network entity, such as a base station) configured according to an aspect of the present disclosure. The example blocks will also be described with respect to RIS controller 401 as illustrated in FIG. 12. FIG. 12 is a block diagram illustrating RIS controller 401 configured according to one aspect of the present disclosure. RIS controller 401 includes the structure, hardware, and components as illustrated for RIS controller 401 or base station 105 of any of FIG. 2, 3A, 3B, or 4. For example, RIS controller 401 includes controller/processor 240, which operates to execute logic or computer instructions stored in memory 242, as well as controlling the components of RIS controller 401 that provide the features and functionality of RIS controller 401. RIS controller 401, under control of controller/processor 240, transmits and receives signals via wireless radios 1201a-t and antennas 234a-t. Wireless radios 1201a-t includes various components and hardware, as illustrated in FIG. 2 for base station 105, including modulator/demodulators 232a-t, MIMO detector 236, receive processor 238, transmit processor 220, and TX MIMO processor 230. As illustrated in the example of FIG. 12, memory 242 stores one or more of RIS configuration logic 1202, RIS measurement logic 1203, RIS information 1204, RIS configuration information 1205, RIS timing information 1206, RIS access information 1207, or RIS settings data 1208. The data (1202-1208) stored in the memory 242 may include or correspond to data and/or logic to enable the operations of FIGS. 4-8B.

At block 1002, a wireless communication device, such as a RIS controller 401, transmits a discovery beacon. The discovery beacon may include or correspond to one or more of the discovery beacon transmission 452 of FIG. 4, the discovery beacon at 510 or 565 of FIG. 5, or the discovery beacon at 720 or 740 of FIG. 7. For example, the RIS controller 401 broadcasts the discovery beacon transmission 452 to one or more nearby devices.

At block 1004, the wireless communication device receives acknowledgement information responsive to the transmission of the discovery beacon. The acknowledgement information may include or correspond to RIS acknowledgement information 408 of FIG. 4, and/or may be included in the discovery beacon acknowledgement 454 of FIG. 4 or the discovery acknowledgement at 515 of FIG. 5, the reconfiguration command at 570 of FIG. 5, or any of the discovery beacon responses at 725, 730, or 745 of FIG. 7. For example, the RIS controller 401 receives the discovery beacon acknowledgement 454, including the RIS acknowledgement information 408, from the UE 115.

At block 1006, the wireless communication device receives reconfigurable intelligent surface (RIS) configuration information for the vehicle based on the transmission of the acknowledgement information. The RIS configuration information indicates one or more RIS configurations of a plurality of RIS configurations for one or more RISs of the vehicle. The RIS configuration information may include or correspond to the RIS configuration information 406 of FIG. 4 and/or may be included in or correspond to the RIS configuration transmission 456 of FIG. 4, the RIS configuration information transmission at 525 of FIG. 5, the RIS configuration information transmission at 610 or 640 of FIG. 6, or the RIS configuration information transmission at 755 of FIG. 5. The RIS configuration information may indicate one or more RIS configurations of a plurality of RIS configurations for one or more RISs of the vehicle, as described with reference to FIGS. 3A, 3B, 4, 8A, and 8B. For example, the RIS controller 401 may transmit the RIS configuration transmission 456, which includes the RIS configuration information 406, to the UE 115. Alternatively, the RIS controller 401 may broadcast the RIS configuration transmission 456, which includes the RIS configuration information 406, to nearby devices, including the UE 115. Although the example illustrated in FIG. 10 is described with reference to a vehicle, in other implementations, the RIS controller may be included in or associated with a building or other structure which may include one or more RISs and may house or contain one or more UEs within.

The wireless communication device (e.g., such as RIS controller, building, or vehicle) may execute additional blocks (or the wireless communication device may be configured to further perform additional operations) in other implementations. For example, the wireless communication device (e.g., RIS controller 401) may perform one or more operations as described with reference to FIGS. 3A-8B. As another example, the wireless communication device may perform one or more aspects as described above with reference to FIGS. 9 and 11 or one or more aspects as presented below.

In a first aspect, the at least one processor is further configured to cause the RIS controller to: transmit a control signal to at least one RIS of the one or more RISs based on received RIS configuration selection information, the control signal configured to adjust a configuration of the at least one RIS.

In a second aspect, alone or in combination with the first aspect, the at least one processor is further configured to cause the RIS controller to: transmit a second discovery beacon; receive second acknowledgement information responsive to the transmission of the second discovery beacon, the second acknowledgement information indicating no reconfiguration requested; and transition to a low power mode (e.g., sleep mode and wakeup for next beacon).

In a third aspect, alone or in combination with one or more of the above aspects, the at least one processor is further configured to cause the RIS controller to: receive second acknowledgement information responsive to the transmission of the discovery beacon, the second acknowledgement information received from a second device different from a first device associated with the acknowledgement information; and transmit access rejection information in response to the transmission of the second acknowledgement information, wherein the access rejection information indicates a remaining duration for the first device associated with the RIS controller and indicates access key information for future access to the RIS controller.

In an additional aspect, the RIS controller is included in a vehicle or a building. In some such aspects, the vehicle includes: one or more reconfigurable intelligent surfaces (RISs); and a reconfigurable intelligent surface (RIS) controller. The RIS controller is configured to: transmit a discovery beacon; receive acknowledgement information responsive to the transmission of the discovery beacon; and transmit RIS configuration information for the vehicle based on the acknowledgement information, the RIS configuration information indicates one or more RIS configurations of a plurality of RIS configurations for the one or more RISs of the vehicle.

In some aspects, each RIS has multiple modes, wherein the multiple modes include a reflective mode, a transmissive mode, and an inactive mode.

Accordingly, wireless communication devices may perform enhanced RIS configuration operations to reduce signal path loss and improve signal strength and quality. Reducing signal path loss may reduce transmission errors and processing latency and enable reduced power consumption, which may lead to better network operations. Accordingly, the network performance and experience may be increased due to reductions in latency, errors, and power consumption.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-12 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A device for wireless communication, comprising:
at least one processor; and
a memory coupled to the at least one processor,
wherein the at least one processor is configured to cause the device to:
receive a discovery beacon from a RIS controller of a vehicle;
transmit acknowledgement information in response to the discovery beacon; and
receive reconfigurable intelligent surface (RIS) configuration information for the vehicle based on the transmission of the acknowledgement information, the RIS configuration information indicating one or more RIS configurations of a plurality of RIS configurations for one or more RISs of the vehicle.

2. The device of claim 1, wherein the RIS configuration information indicates a RIS configuration for a single RIS configuration of the plurality of RIS configurations.

3. The device of claim 1, wherein the RIS configuration information indicates RIS configurations for multiple RIS configurations of the plurality of RIS configurations.

4. The device of claim 1, wherein the RIS configuration information comprises RIS configuration index information for a single RIS configuration of the plurality of RIS configurations and RIS settings information corresponding to the single RIS configuration.

5. The device of claim 4, wherein the RIS configuration information further includes RIS configuration timing information corresponding to the single RIS configuration.

6. The device of claim 1, wherein the RIS configuration information comprises RIS configuration index information for multiple RIS configurations of the plurality of RIS configurations and RIS settings information corresponding to the multiple RIS configurations.

7. The device of claim 6, wherein the RIS configuration information further includes RIS configuration timing information corresponding to the multiple RIS configurations.

8. The device of claim 6, wherein the RIS configuration index information indicates an identifier for each RIS configuration of the vehicle included in the RIS configuration information, and wherein the RIS settings information comprises a bitmap indicating configuration settings of each RIS of the vehicle.

9. The device of claim 1, wherein the at least one processor is configured to cause the device to:
transmit RIS configuration command information based on the RIS configuration information; and
perform one or more measurement operations on transmissions received from a second device based on the RIS configuration information and responsive to the transmission of the RIS configuration command information.

10. The device of claim 1, wherein the at least one processor is configured to cause the device to:
transmit a RIS configuration command based on the RIS configuration information;
receive a RIS configuration confirmation message based on the transmission of the RIS configuration command; and
perform one or more measurement operations on transmissions received from a second device using the one or more RIS configurations.

11. The device of claim 10, wherein the at least one processor configured to cause the device to perform the one or more measurement operations includes to:
perform a plurality of measurements responsive to the RIS configuration confirmation message, each measurement corresponding to a particular transmission from the second device and using a particular RIS configuration of the plurality of RIS configurations indicated by the RIS configuration information;
select a RIS configuration from among the plurality of RIS configurations based on comparisons of the plurality of measurements; and
transmit an indication of the selected RIS configuration to the RIS controller configured to cause the RIS controller to set the selected RIS configuration as a final configuration.

12. The device of claim 11, wherein the at least one processor configured to cause the device to perform the plurality of measurements includes to:
perform measurements on Synchronization Signal Block (SSB) transmissions from a base station which are redirected by the one or more RISs of the vehicle.

13. The device of claim 12, wherein the at least one processor configured to cause the device to perform measurements on SSB transmissions includes to:
perform a first measurement on a first SSB transmission from the base station using a first RIS configuration of the RIS configuration information; and
perform a second measurement on a second SSB transmission from the base station using a second RIS configuration of the RIS configuration information.

14. The device of claim 13, wherein the at least one processor configured to cause the device to select the RIS configuration includes to:
compare the first measurement to the second measurement; and
select the first RIS configuration based on determining the first measurement is greater than the second measurement.

15. The device of claim 13, wherein the first measurement corresponds to a received signal strength indicator (RSSI), a reference signal received power (RSRP), a reference signal received quality (RSRQ), or a signal to interference plus noise ratio (SINR).

16. The device of claim 10, wherein the at least one processor configured to cause the device to perform the one or more measurement operations includes to:
perform a first measurement responsive to the RIS configuration confirmation message;
receive a second RIS configuration confirmation message based on the transmission of the RIS configuration command; and
perform a second measurement responsive to the second RIS configuration confirmation message.

17. The device of claim 16, wherein the at least one processor configured to cause the device to select the RIS configuration includes to:
compare the first measurement to a threshold;
determine to keep evaluating RIS configurations based on the first measurement not satisfying the threshold;
compare the second measurement to the threshold;
determine to select a RIS configuration associated with the second measurement based on the second measurement satisfying the threshold; and
transmit an indication to the RIS controller configured to cause the RIS controller to set the RIS configuration associated with the second measurement as a selected RIS configuration.

18. The device of claim 1, wherein the at least one processor is configured to cause the device to:
receive a second discovery beacon from the RIS controller, wherein the second discovery beacon is successfully received and decoded;
determine whether to change a current RIS configuration based measurement information; and
transmit second acknowledgement information indicating a negative acknowledgement in response to the successful receipt and decoding of the second discovery beacon and based on a determination to not change the RIS configuration.

19. The device of claim 1, wherein the at least one processor is configured to cause the device to:
receive a second discovery beacon from the RIS controller, wherein the second discovery beacon is successfully received and decoded;
determine whether to change a current RIS configuration based measurement information; and
transmit second acknowledgement information indicating a positive acknowledgement in response to the successful receipt and decoding of the second discovery beacon and based on a determination to change the RIS configuration.

20. The device of claim 19, wherein the at least one processor configured to cause the device to determine whether to change the current RIS configuration based measurement information includes to:
determine that a measured parameter is less than or equal to a RIS reconfiguration threshold;
determine that a change in a measured parameter is less than or equal to a RIS reconfiguration change threshold;
determine that a direction of the vehicle has changed;
determine that the device has moved positions within the vehicle;
determine that a handover has occurred; or
determine that a RIS configuration timer has elapsed.

21. The device of claim 19, wherein the at least one processor is configured to cause the device to:
transmit a second RIS configuration command based on the determination to change the RIS configuration and optionally the RIS configuration information or second RIS configuration information;
receive a second RIS configuration confirmation message based on the transmission of the second RIS configuration command;
perform one or more second measurement operations on second transmissions received from a second device;
select a second RIS configuration based on the one or more second measurement operations; and
transmit a second RIS configuration selection based on the selected second RIS configuration.

22. The device of claim 1, wherein the at least one processor is configured to cause the device to:
receive access rejection information in response to the transmission of the acknowledgement information;
receive a second discovery beacon from the RIS controller; and
transmit second acknowledgement information in response to the second discovery beacon, wherein the RIS configuration information is received responsive to the transmission of the second acknowledgement information.

23. The device of claim 22, wherein the access rejection information indicates a remaining duration for another device associated with the RIS controller.

24. The device of claim 22, wherein the access rejection information indicates future access information in response to the transmission of the acknowledgement information, and wherein the second acknowledgement information indicates the future access information.

25. A reconfigurable intelligent surface (RIS) controller, comprising:
at least one processor; and
a memory coupled to the at least one processor,
wherein the at least one processor is configured to cause the RIS controller to:
transmit a discovery beacon;
receive acknowledgement information responsive to the transmission of the discovery beacon; and
transmit RIS configuration information for one or more reconfigurable intelligent surfaces (RISs) associated with the RIS controller based on the acknowledgement information, the RIS configuration information indicating one or more RIS configurations of a plurality of RIS configurations for the one or more RISs.

26. The RIS controller of claim 25, wherein the at least one processor is configured to cause the RIS controller to:
transmit a control signal to at least one RIS of the one or more RISs based on received RIS configuration selection information, the control signal configured to adjust a configuration of the at least one RIS.

27. The RIS controller of claim 25, wherein the at least one processor is configured to cause the RIS controller to:
transmit a second discovery beacon;
receive second acknowledgement information responsive to the transmission of the second discovery beacon, the second acknowledgement information indicating no reconfiguration requested; and
transition to a low power mode.

28. The RIS controller of claim 25, wherein the at least one processor is configured to cause the RIS controller to:
receive second acknowledgement information responsive to the transmission of the discovery beacon, the second acknowledgement information received from a second device different from a first device associated with the acknowledgement information; and
transmit access rejection information in response to the transmission of the second acknowledgement information, wherein the access rejection information indicates a remaining duration for the first device associated with the RIS controller and indicates access key information for future access to the RIS controller.

29. A vehicle for wireless communication, comprising:
one or more reconfigurable intelligent surfaces (RISs); and
a reconfigurable intelligent surface (RIS) controller, the RIS controller configured to:
transmit a discovery beacon;
receive acknowledgement information responsive to the transmission of the discovery beacon; and
transmit RIS configuration information for the vehicle based on the acknowledgement information, the RIS configuration information indicating one or more RIS configurations of a plurality of RIS configurations for the one or more RISs of the vehicle.

30. The vehicle of claim 29, wherein each RIS has multiple modes, wherein the multiple modes include a reflective mode, a transmissive mode, and an inactive mode.
